(19) United States
(12) Patent Application Publication
(10) Pub. No.: US 2004/0154364 A1
(43) Pub. Date: Aug. 12, 2004

(54) Modular latch apparatus and method

(75) Inventors: Steven J. Dimig, Plymouth, WI (US); Alan J. Ritz, Brookfield, WI (US)

Correspondence Address: MICHAEL BEST & FRIEDRICH, LLP, 100 E WISCONSIN AVENUE, MILWAUKEE, WI, 53202, US

(73) Assignee: STRATTEC SECURITY CORPORATION

(21) Appl. No.: 10/764,746

(22) Filed: Jan. 26, 2004

Related U.S. Application Data
(62) Division of application No. 09/408,993, filed on Sep. 29, 1999, now abandoned.
Application No. 09/408,993 is a continuation-in-part of application No. 09/263,415, filed on Mar. 5, 1999, now Pat. No. 6,463,773.

(51) Int. Cl. E05B 47/00

(52) U.S. Cl. 70/279.1

(57) ABSTRACT

A modular latch assembly having at least one control element having one path of motion in which a ratchet is moved to an unlatched position and another path of motion in which the ratchet is not so moved, the path of motion taken by the control element dependent upon whether an engagement element is extended into engagement with the control element or retracted from engagement therewith. Preferably, the control element moves the ratchet by contact with a pawl which itself can be engaged with the ratchet. A manual override can be installed for manually shifting an engagement element into and out of engagement with a control element to place the control element in latched and unlatched states as desired. The latch assembly is preferably provided with a number of different control element positions for receiving control elements therein, each of which is actuatable to move the pawl when in an unlocked state. The number of control elements selected, their selected positions in the latch assembly, and their connection arrangement to input elements are highly flexible, providing latch adaptability to a large number of applications and latch functionalities. The latch assembly preferably has elements arranged and assembled in layers to increase assembly ease and speed. A highly preferred embodiment of the invention includes an automatic unlocking circuit powered by a backup power source.

### CROSS-REFERENCE TO RELATED APPLICATIONS

This is a divisional of U.S. patent application Ser. No. 09/408,993 filed on Sep. 29, 1999, which is a continuation-in-part of U.S. patent application Ser. No. 09/263,415 filed on Mar. 5, 1999 and issued on Oct. 15, 2002 as U.S. Pat. No. 6,463,773. Priority is hereby claimed to both earlier-filed patent applications.

### FIELD OF THE INVENTION

The present invention relates to latches and latching methods, and more particularly to devices and methods for controlling and switching a latch between latched and unlatched states.

### BACKGROUND OF THE INVENTION

Conventional latches are used to restrain the movement of one member or element with respect to another. For example, conventional door latches restrain the movement of a door with respect to a surrounding door frame. The function of such latches is to hold the door secure within the frame until the latch is released and the door is free to open. Existing latches typically have mechanical connections linking the latch to actuation elements such as handles which can be actuated by a user to release the latch. Movement of the actuation elements is transferred through the mechanical connections and will cause the latch to release. The mechanical connections can be one or more rods, cables, or other suitable elements or devices. Although the following discussion is with reference to door latches (e.g., especially for vehicle doors), the background information provided applies equally to a wide variety of latches used in other applications.

Most current vehicle door latches contain a restraint mechanism for preventing the release of the latch without proper authorization. When in a locked state, the restraint mechanism blocks or impedes the mechanical connection between the handle and a latch release mechanism, thereby locking the door. Many conventional door latches also have two or more lock states, such as unlocked, locked, child locked, and dead locked states. Inputs to the latch for controlling the lock states of the latch can be mechanical, electrical, or parallel mechanical and electrical inputs. For example, by the turn of a user's key, a cylinder lock can mechanically move the restraint mechanism, thereby unlocking the latch. As another example, cable or rod elements connecting a door handle to the latch release mechanism can be controlled by one or more electrical power actuators. These actuators, sometimes called “power locks” can use electrical motors or solenoids as the force generator to change between locked and unlocked states.

A number of problems exist, however, in the conventional door latches described above. For example, conventional restraint mechanisms in such latches are typically quite complex, with numerous parts often having relatively complicated movements. Such latches are thus more expensive to manufacture, assemble, maintain, and repair. This problem is compounded in latches having multiple lock states as mentioned above. These latches often require separate sets of elements corresponding to and controlling each lock state of the latch.

In addition, because conventional door latches are typically relatively complex (especially latches having multiple lock states), the ability of a latch design to be used in diverse applications suffers significantly. For example, many conventional door latches are suitable for installation in a particular door, but cannot readily be installed in other door designs. As another example, door latch applications in which only limited latching functions are needed generally call for a different door latch than door latch applications in which full latching functions are needed. Conventional door latches are far from being “universal” (capable of installation in a number of different applications and easily adaptable to applications varying in functionality). Therefore, it is often necessary for a manufacturer, installer, or servicer of door latches to keep a wide variety of different door latches in inventory—an expensive and inefficient practice.

Space and location constraints for door latches varies significantly from application to application. In some applications for example, connecting rods are used to mechanically link door handles or user-operable lock buttons to the latch, while in other applications bowden cables are more suitable. As used herein and in the appended claims, the terms “user-operable”, “user-actuatable”, and the like include direct and indirect user operation and actuation. Therefore, devices or elements described in such manner include those that are operated upon or actuated indirectly by a user in some manner (e.g., via electronic actuation, mechanical linkage, and the like), and are not necessarily limited to devices or elements intended for direct contact and manipulation by a user in normal operations of the latch.

The latch space and location constraints mentioned above can also require latch connections to be made only from certain sides or the latch or only at certain angles with respect to portions of the latch. Conventional latch manufacturers address such problems by providing specialized latches for specific applications or groups of applications. Once again, this solution requires a manufacturer, installer, or servicer of door latches to incur the expense of keeping a wide variety of different door latches in inventory.

For obvious reasons, increased latch complexity also has a significant impact upon assembly and repair cost. Conventional door latches are generally difficult to assemble and require a significant amount of assembly time. An assembler must often orient the latch assembly in several directions during the assembly process (i.e., flip the latch over or turn the latch repeatedly). Also, the large number of small and intricate parts typically used in conventional door latches adds to assembly cost. Particularly in light of the specialized nature, function, and redundancy of many door latch parts, conventional door latches designs are far from being optimized.

Problems of latch weight and size are related to the problem of latch complexity. The inclusion of more elements and more complex mechanisms within the latch generally undesirably increases the size and weight of the latch. In virtually all vehicle applications, weight and size of any component is a concern. Additionally, increased weight and size of elements and assemblies within the latch necessarily requires more power and greater force to operate the latch. Because power is also at a premium in many applications (especially in vehicular applications), numerous elements and complex assemblies within conventional door latches are an inefficiency that is often wrongly ignored. Not only are larger and more complex latches a power drain, but such latches are typically unnecessarily slow.

Another problem with conventional door latches relates to their operation. Particularly where a latch has multiple lock states, the ability of a user to easily and fully control the latch in its various lock states is quite limited. For example, many latches having a child locked state (i.e., the inside door handle is disabled but the outside door handle is not) require a user to manually set the child locked state by manipulating a lever or other device on the latch. Other latches do not permit the door to enter a dead locked state (i.e., both the inside and outside door handles being disabled). Also, conventional door latches generally do not permit a user to place the door latch in all lock states remotely, such as by a button or buttons on a key fob. These examples are only some of the shortcomings in existing door latch operability.

Still another problem of conventional door latches is related to power locks. The design of existing power lock systems has until now significantly limited the safety of the latch. Latch design limitations exist in conventional latches to ensure, for example, that dead locked latches operated by powered devices or systems will reliably unlock in the event of power interruption or failure. Such limitations have resulted in latch designs which permit less than optimal user operability. Although manual overrides for conventional door latches do exist, these overrides typically add a significant amount of complexity to the door latch and are difficult to install and assemble. Therefore, a reliable design having a failure mode and a simple manual override for an electrically powered latch which is electrically actuatable in all locked states remains an elusive goal.

In conventional door latches, yet another problem is caused by the fact that an unauthorized user can often manipulate the restraint mechanism within the latch and/or the connections of the latch to the door locks to unlock the latch. Because existing conventional door latches have at least some type of mechanical linkage from the user-actuated elements (e.g., lock cylinders) to the restraint mechanism in the latch, the ability of an unauthorized user to unlock the latch as just described has been a persistent problem.

In light of the problems and limitations of the prior art described above, a need exists for a latch assembly which can be used in many applications, is modular and which therefore has easily adaptable functionality to meet the needs of a large number of applications (i.e., from limited to full functionality), has the fewest elements and assemblies possible, is smaller, faster, and lighter than existing latches, consumes less power in operation, is less expensive and easier to manufacture, assemble, maintain, and repair, provides a high degree of flexibility in user operation to control the lock states of the latch, has a simple and reliable design for manual override in the event of power interruption or failure, and offers improved security against unlocking by an unauthorized user. Each preferred embodiment of the present invention achieves one or more of these results.

### SUMMARY OF THE INVENTION

In the most highly preferred embodiments of the latch assembly of the present invention, unlocked and locked states of the latch assembly are established by at least two different types of movement of a control element. The control element moves in a first manner through a first path when the latch assembly is in an unlocked state and in a second manner through a second path when the latch assembly is in a locked state. When the control element moves in the first manner, the control element imparts motion either directly or indirectly to a latch element or mechanism (e.g., a ratchet). Such motion moves the latch element or mechanism to move to its unlatched position to unlatch the door. In contrast, when the control element moves in a second manner, the control element does not impart motion (or sufficient motion) to the latch element or mechanism for unlatching the door. Therefore, whether movement or actuation of the control element by a user will unlatch the latch depends upon whether the control element moves in the first or the second manner. The latch assembly of the present invention operates to quickly change the manner of control element motion by preferably extending or retracting one or more elements that guide or limit the motion of the control element. These elements are preferably pins which are quickly extended and retracted by one or more actuators, although other elements can be used effectively.

A highly preferred embodiment of the present invention has two control elements, pins, and actuators. In each control element, pin, and actuator set, the actuator can be extended to extend the pin into a hole in the control element and can also be retracted to retract the pin from the hole. When the actuator and pin are extended and thereby engage the control element, the control element preferably pivots through a first path about a first pivot point. However, when the actuator and pin are retracted and are thereby disengaged from the control element, the control element preferably pivots through a second path about a second pivot point. Movement of the control element through the first path preferably brings the control element into contact with a pawl that is coupled to the latch element or mechanism. This contact causes the latch element or mechanism to release, thereby unlatching the door. The control element in the first path is therefore is in an unlocked state. In contrast, movement of the control element through the second path preferably does not bring the control element into such contact, or at least into contact sufficient to release the latch element or mechanism. The control element in the second path therefore is in a locked state.

In the most highly preferred embodiments of the present invention, the actuators are electromechanical solenoids that perform quick retraction and extension operations to engage and disengage the control elements in their different lock states. The control elements preferably pivot about a hole in each control element that is engaged by the pin in the extended position and about another pivot point or about post, peg, or other element extending from each control element when the pin is not engaged therewith.

In referring herein to “retraction” and “extension” operations of solenoids and to “retracted” and “extended” positions of the solenoids, it should be understood that this is with reference to well known operation of conventional solenoids. Specifically, solenoids typically have one or more elements (such as an armature) which are controllable to extend and retract from the remainder of the solenoid in a well known manner. Terms such as retraction, retracted, extension and extended used herein in connection with a solenoid refers to such conventional solenoid operations. It will be apparent that modified solenoids or other actuators can be used without departing from the present invention.

When the latch assembly of the present invention is used on a vehicle door, a first control element is coupled via a linking member to an inside door handle and a second control element is preferably coupled to an outside door handle. When the pin corresponding to each control element is extended to engage the first and second control elements, respectively, actuation of the control elements by either handle causes the actuated control element to directly or indirectly move a ratchet to unlatch the door. This is the unlocked state of the latch assembly. When the pin corresponding to each control element is retracted to disengage the first and second control elements, actuation of the control elements by either handle does not move the ratchet or does so insufficiently to unlatch the door. This is the dead locked state of the latch assembly. When the pin corresponding to the first control element is extended to engage the first control element and when the pin corresponding to the second control element is retracted to disengage the second control element, actuation of the inside door handle will directly or indirectly move a ratchet to unlatch the door, but actuation of the outside door handle will not do so. This is the locked state of the latch assembly. When the pin corresponding to the first control element is retracted to disengage the first control element and the pin corresponding to the second control element is extended to engage the second control element, actuation of the outside door handle will move the pawl and unlatch the door, but actuation of the inside door handle will not do so. This is the child locked state of the latch assembly. Of course, in other embodiments of the present invention, one, three, or even more control element, pin, and actuator sets can be used as desired.

Latch assembly operations for placing the control elements in their locked and unlocked states are therefore quickly performed via actuators, and most preferably, by electromagnetic solenoids. Also, the relatively small number of elements (e.g., an actuator, pin, control element, and, if desired, a pawl as described in more detail below) employed to place the latch assembly in its various lock states is a significant advantage over prior art latches. The latch assembly of the present invention is therefore lighter, smaller, can be operated using less power, and can be manufactured, maintained, and repaired at less expense.

In addition, the use of actuators such as electromagnetic solenoids to place the control elements in their various states provides greater flexibility for controlling the various latch assembly lock states.

The latch assembly of the present invention also preferably has a control circuit for controlling the actuators. Most preferably, the control circuit is electrical and uses a sensing device to detect changes in the primary power supply (e.g., power loss, power interruption, etc.) supplying power to the latch assembly and to the actuators. At least as a safety feature, certain changes detected in the power supply preferably cause the actuators to automatically engage the pins with the control elements and to thereby unlock the latch assembly. Because the mechanism for placing the latch assembly in its various lock states is preferably actuated electronically rather than by conventional mechanical means, the latch assembly is also more secure against unauthorized operation.

In addition to the above-noted advantages of the present invention, the latch assembly is also highly adaptable for installation in a number of different applications and in a number of different configurations, thereby providing a latch which can easily be changed from a latch having minimal functionality to a latch with full functionality, and to a number of different states in between. First, the latch assembly preferably provides linking access to the control elements therein (e.g., capability to connect the control elements to actuation elements external to the latch assembly via cables, rods, or other “input” or “linking” elements) either by ports for interior linking or by housing apertures permitting control elements to extend outside of the latch assembly for exterior linking. Second, the input elements linked to the latch assembly for actuation thereof are preferably fully interchangeable with multiple control elements and with the pawl. The control elements and the pawl can therefore be connected in a number of different ways to the actuation elements, thereby providing a large amount of flexibility to install the latch for operation in a variety of different ways. Third, the latch assembly preferably has a sufficient number of control element and actuator positions so that an assembler can selectively install one or more control elements and actuators in desired locations to create a latch assembly best suited for a particular application. By selecting how many control elements and associated actuators are to be installed (and where) in each particular latch, the assembler is able to easily modify each latch for a specific application without requiring any modification to the latch assembly.

The latch assemblies of the present invention preferably also have at least one manual override which permits a user to manually shift an engagement element into engagement with a control element to establish an unlocked state of the control element. Such a manual override can also or instead permit a user to manually shift an engagement element out of engagement with a control element to establish a locked state of the control element. In a highly preferred embodiment, the manual override is also capable of shifting an engagement element in such manner in response to movement of another control element in its unlocked state or in response to movement of the pawl to its unlocked state.

Another feature of the present invention is related to its assembly. Specifically, the latch assemblies are preferably assembled in layers of elements. Most preferably, a majority of elements are positioned and installed within the latch layer upon layer without requiring numerous re-orientations of the latch assembly by the assembler and without requiring access to more than one side of the latch assembly. This saves considerable assembly, service, and maintenance time, thereby lowering the cost to manufacture, service, and maintain the latch.

More information and a better understanding of the present invention can be achieved by reference to the following drawings and detailed description.

### BRIEF DESCRIPTION OF THE DRAWINGS

The present invention is further described with reference to the accompanying drawings, which show preferred embodiments of the present invention. However, it should be noted that the invention as disclosed in the accompanying drawings is illustrated by way of example only. The various elements and combinations of elements described below and illustrated in the drawings can be arranged and organized differently to result in embodiments which are still within the spirit and scope of the present invention.

In the drawings, wherein like reference numerals indicate like parts:

FIG. 1 is a front perspective view, looking down, of a latch mechanism according to a first preferred embodiment of the present invention;

FIG. 2 is a front perspective view, looking up, of the latch mechanism shown in FIG. 1;

FIG. 3 is a rear perspective view, looking down, of the latch mechanism shown in FIGS. 1 and 2;

FIG. 4 is an exploded view of the latch mechanism shown in FIGS. 1-3, viewed from the front;

FIG. 5 is an exploded view of the latch mechanism shown in FIGS. 1-4, viewed from the rear;

FIG. 6 is a front perspective view of the latch mechanism shown in FIGS. 1-5, with the front cover and actuators removed;

FIG. 7 is a front perspective view of the latch mechanism shown in FIGS. 1-6, with the front cover, actuators, and the cover plate removed, and showing the control elements and the pawl of the latch mechanism;

FIG. 8 is a front elevational view of the latch mechanism shown in FIG. 7, with both the right and left control elements in their unactuated positions;

FIG. 9 is a front elevational view of the latch mechanism shown in FIG. 7, with the latch mechanism unlocked and with the right control element actuated;

FIG. 10 is a front elevational view of the latch mechanism shown in FIG. 7, with the latch mechanism unlocked and with the left control element actuated;

FIG. 11 is a front elevational view of the latch mechanism shown in FIG. 7, with the latch mechanism locked and with the right control element actuated;

FIG. 12 is a front elevational view of the latch mechanism shown in FIG. 7, with the latch mechanism locked and with the left control element actuated;

FIG. 13 is a rear elevational view of the latch mechanism shown in FIGS. 1-12, with the rear mounting plate removed and with the pawl engaged with the ratchet;

FIG. 14 is a rear elevational view of the latch mechanism shown in FIGS. 1-13, with the rear mounting plate removed and with the pawl disengaged from the ratchet;

FIG. 15 is a schematic diagram of a control circuit for the latch assembly of the present invention according to a preferred embodiment of the present invention;

FIG. 16 is a exploded perspective view of a portion of the latch assembly with a manual override according to a preferred embodiment of the present invention.

FIG. 17 is a front perspective view, looking down, of a latch mechanism according to a second preferred embodiment of the present invention;

FIG. 18 is a front perspective view, looking up, of the latch mechanism shown in FIG. 17;

FIG. 19 is a rear perspective view, looking down, of the latch mechanism shown in FIGS. 17 and 18;

FIG. 20 is an exploded view of the latch mechanism shown in FIGS. 17-19, viewed from the front;

FIG. 21 is an exploded view of the latch mechanism shown in FIGS. 17-20, viewed from the rear;

FIG. 22 is a front perspective view of the latch mechanism shown in FIGS. 17-21, with the front cover, actuators, and manual override device removed;

FIG. 23 is a perspective detail view of FIG. 22, showing the manual override device;

FIG. 24 is a front perspective view of the latch mechanism shown in FIGS. 17-23, with the front cover, actuators, circuit board and the cover plate removed, and showing the control elements and the pawl of the latch mechanism;

FIG. 25 is a front elevational view of the latch mechanism shown in FIG. 24, with both the upper and lower control elements in their unactuated positions;

FIG. 26 is a front elevational view of the latch mechanism shown in FIG. 24, with the latch mechanism unlocked and with the upper control element actuated;

FIG. 27 is a front elevational view of the latch mechanism shown in FIG. 24, with the latch mechanism unlocked and with the lower control element actuated;

FIG. 28 is a front elevational view of the latch mechanism shown in FIG. 24, with the latch mechanism locked and with the upper control element actuated;

FIG. 29 is a front elevational view of the latch mechanism shown in FIG. 24, with the latch mechanism locked and with the lower control element actuated;

FIG. 30 is a rear elevational view of the latch mechanism shown in FIGS. 17-29, with the rear mounting plate removed and with the pawl engaged with the ratchet;

FIG. 31 is a rear elevational view of the latch mechanism shown in FIGS. 17-30, with the rear mounting plate removed and with the pawl disengaged from the ratchet;

FIG. 32 is a front elevational view of a latch mechanism according to a third preferred embodiment of the present invention, with the front cover, actuators, cover plate, and circuit board removed and with the control elements in their unactuated positions;

FIG. 33 is a front elevational view of the latch mechanism shown in FIG. 32, with the latch mechanism unlocked and with the lower control element actuated; and

FIG. 34 is a front elevational view of the latch mechanism shown in FIG. 32, with the latch mechanism locked and with the lower control element actuated.

### DETAILED DESCRIPTION OF THE PREFERRED EMBODIMENTS

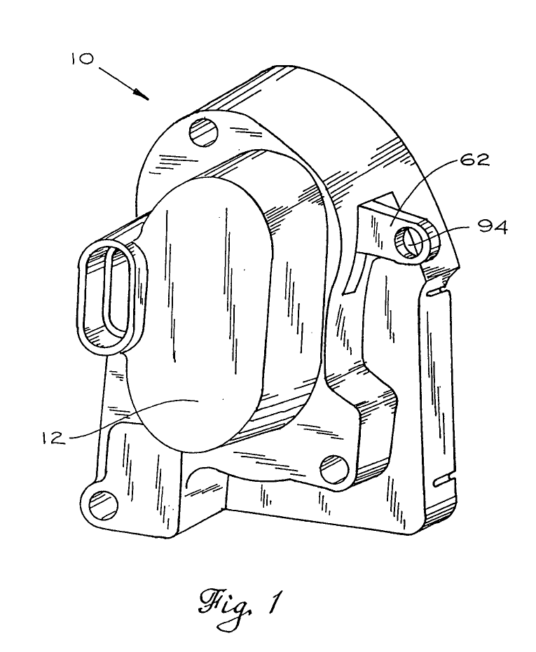

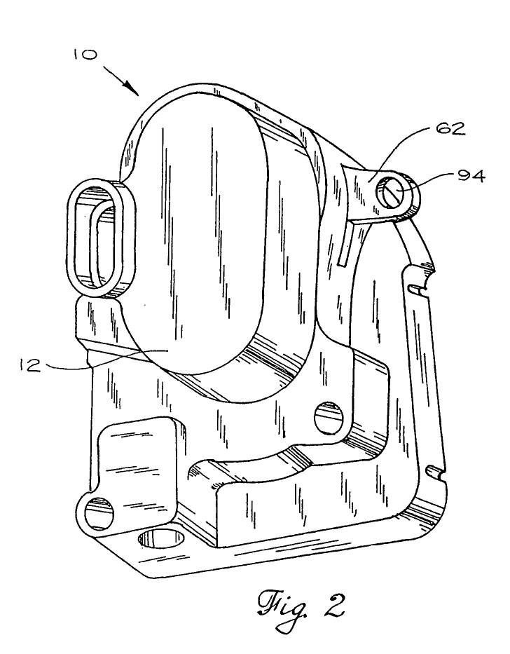

While the latch assembly 10 of the present invention is useful in a variety of applications, it is particularly useful in vehicle applications such as for automotive and truck doors. In such applications, the latch assembly 10 preferably has a front cover 12, a rear mounting plate 14 and a housing 16 which collectively enclose the internal elements and mechanisms of the latch assembly 10. A highly preferred embodiment of the latch assembly 10 is shown in FIGS. 1-3. It should be noted that although the following description is with reference to the latch assembly 10 used in vehicle door applications (where application of the latch assembly 10 can be employed with excellent results), the latch assembly 10 can instead be used in many other applications. In fact, the present invention can be used in any application in which it is desirable to releasably secure one body to another. Such applications can be non-automotive and even in applications not involving doors.

The terms of orientation and direction are used herein for ease of description only and do not indicate or imply any required limitation of the present invention. For example, terms such as front, rear, left, right, clockwise, counterclockwise, upper, lower, top, bottom, first, and second as used herein do not indicate or imply that the elements or operations thus described must be oriented or directed in a particular way in the practice of the present invention. One having ordinary skill in the art will recognize that opposite or different orientations and directions are generally possible without departing from the spirit and scope of the present invention. Also, it should be noted that throughout the specification and claims herein, when one element is said to be “coupled” to another, this does not necessarily mean that one element is fastened, secured, or otherwise attached to another element. Instead, the term “coupled” means that one element is either connected directly or indirectly to another element or is in mechanical communication with another element. Examples include directly securing one element to another (e.g., via welding, bolting, gluing, mating, etc.), elements which can act upon one another (e.g., via camming, pushing, or other interaction) and one element imparting motion directly or through one or more other elements to another element.

Where the latch assembly 10 secures a vehicle door to a door frame or vehicle body, the latch assembly 10 is preferably mounted in a conventional manner to the vehicle door. For example, the rear mounting plate 14 can be provided with fastener holes 18 through which threaded or other conventional fasteners (not shown) are passed and secured to the door. The latch assembly 10 can be secured to the door or to the vehicle body in a number of manners, such as by welding, screwing, bolting, riveting, and the like, all of which are well known to those skilled in the art. Further discussion of securement methods and elements is therefore not provided herein.

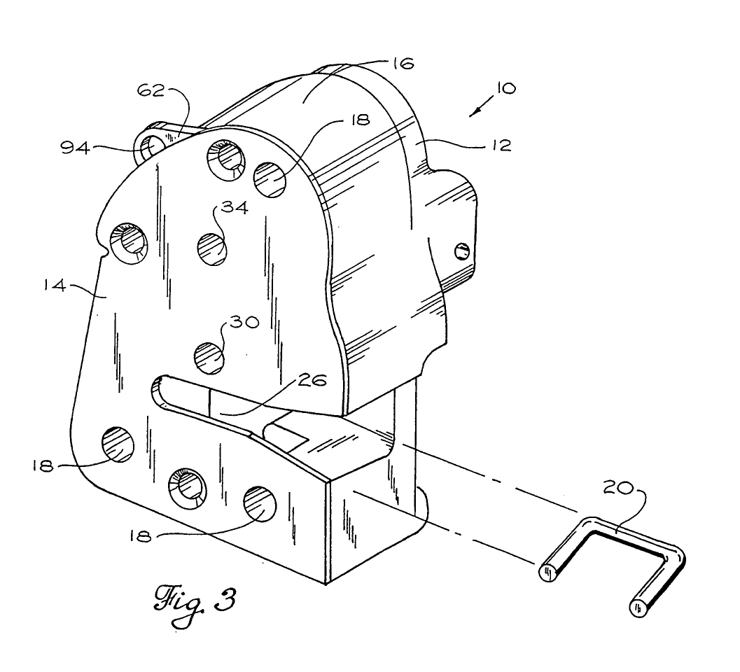

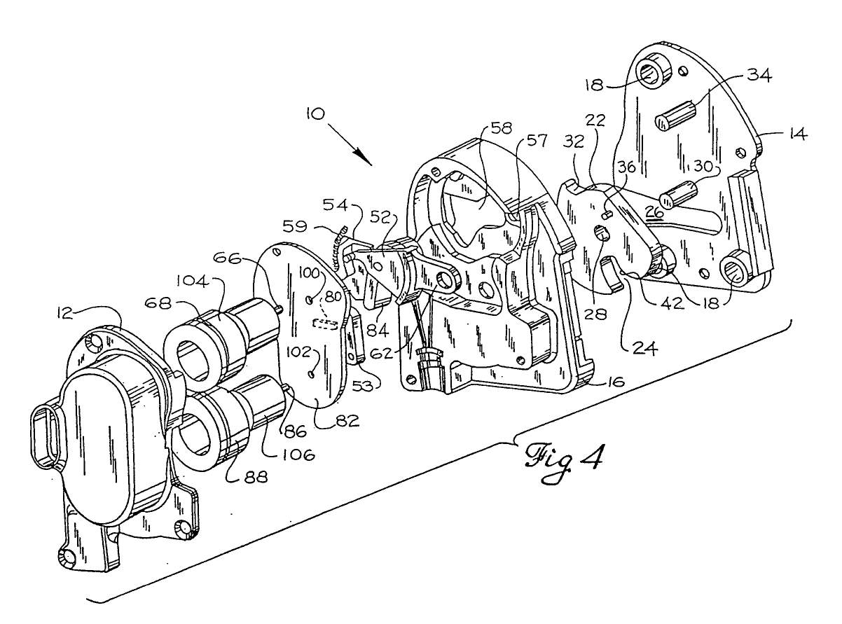

Similar to conventional latch assemblies, the latch assembly 10 is designed to releasably capture a striker 20 (see FIG. 3) mounted on the vehicle body (or on the door if the latch assembly 10 is instead mounted on the vehicle body). For this purpose, the latch assembly 10 preferably has a ratchet or fork bolt 22 (see FIGS. 4, 5, 13, and 14) rotatably mounted therein for releasably capturing the striker 20. The ratchet 22, the rear mounting plate 14, and the housing 16 each have a groove 24, 26, 27, respectively, for receiving and capturing the striker 20 to latch the door shut. Specifically, the ratchet 22 is rotatable between a fully open position in which the grooves 24, 26, 27 align with one another to receive the striker 20, and a range of closed positions in which the ratchet 22 is rotated to reposition the groove 24 of the ratchet 22 out of alignment with the grooves 26, 27 of the rear mounting plate 14 and the housing 16 (thereby capturing the striker 20 within the grooves 24, 26, 27). It should be noted that a number of different striker and ratchet designs exist which operate in well known manners to releasably secure a striker (or like element) to a ratchet (or like element). The preferred embodiments of the present invention are useful with these other conventional striker and ratchet designs as well. Such other striker and ratchet designs fall within the spirit and scope of the present invention.

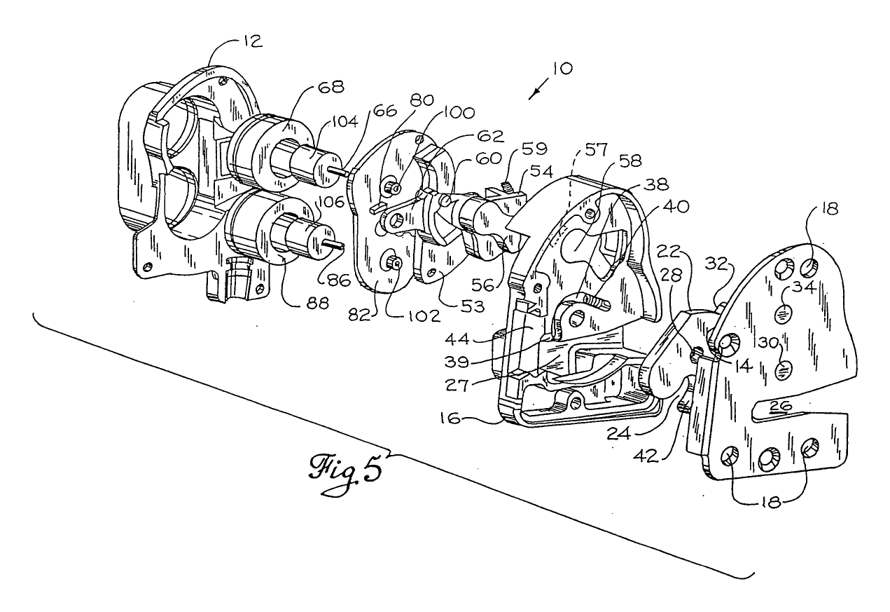

With particular reference to FIGS. 4 and 5, the operation of the ratchet 22 in capturing and securing the striker 20 within the latch assembly 10 will now be further described. As indicated above, the use of a ratchet in a latch mechanism is well known to those skilled in the art. In the latch assembly 10 of the present invention, the ratchet 22 is preferably provided with an aperture 28 for mounting the ratchet 22 to the rear mounting plate 14. The aperture 28 is sized and shaped to rotatably receive a lower pivot post 30 extending from the rear mounting plate 14. The lower pivot post 30 is preferably fastened to the rear mounting plate 14 in a conventional manner, such as by a riveting, screwing, bolting, or other conventional fastening techniques. The lower pivot post 30 can instead be made integral with the rear mounting plate 14. Sufficient clearance is provided between the lower pivot post 30 and the aperture 28 of the ratchet 22 so that the ratchet 22 can rotate substantially freely about the lower pivot post 30.

In order to control the movement of the ratchet 22 within the latch assembly 10, rotation of the ratchet 22 is preferably limited at two locations as follows. First, the ratchet 22 is prevented from rotation beyond the point where the grooves 24, 26, 27 of the ratchet 22, the rear mounting plate 14, and the housing 16 are aligned for receiving the striker 20 as described above. This limitation exists due primarily to the manner in which the striker 20 moves through the grooves 24, 26, 27 as it enters the latch assembly 10. When the striker 20 has rotated the ratchet 22 to the position shown in FIGS. 4 and 5, the striker 20 is preferably stopped by an elastomeric element 44 (described in more detail below) located between the rear mounting plate 14 and the housing 16. Because the striker 20 is trapped between the grooves 24, 26, 27 of the ratchet 22, the rear mounting plate 14, and the housing 16 in this position, the ratchet 22 cannot rotate further in the counterclockwise direction as viewed in FIG. 4. In addition, the ratchet 22 is preferably provided with a stop pin 36 which fits into a stop pin groove 38 in the housing 16 (see FIG. 5). As best viewed in FIG. 5, a ratchet spring 40 is also preferably fitted within the stop pin groove 38 and exerts a reactive force against the stop pin 36 when compressed by rotation of the ratchet 22 in the counterclockwise direction as viewed in FIG. 4. Therefore, when the ratchet 22 is rotated in the counterclockwise direction as viewed in FIG. 4, the ratchet spring 40 and the termination of the stop pin groove 38 in the housing 16 prevents further rotation of the ratchet 22 in the same direction.

To limit movement of the ratchet 22 in the clockwise direction as viewed in FIG. 4, the stop pin groove 38 has a terminal section 39 (see FIG. 5) within which the stop pin 36 is stopped when the ratchet 22 is rotated under force of the ratchet spring 40 in the clockwise direction as viewed in FIG. 4. As such, the ratchet 22 is effectively limited in movement in one direction by the stop pin 36 against the ratchet spring 40 and by the striker 20 stopped by the elastomeric element 44 and trapped within the grooves 24, 26, 27, and limited in movement in the opposite direction by the stop pin 36 within the terminal section 39 of the stop pin groove 38.

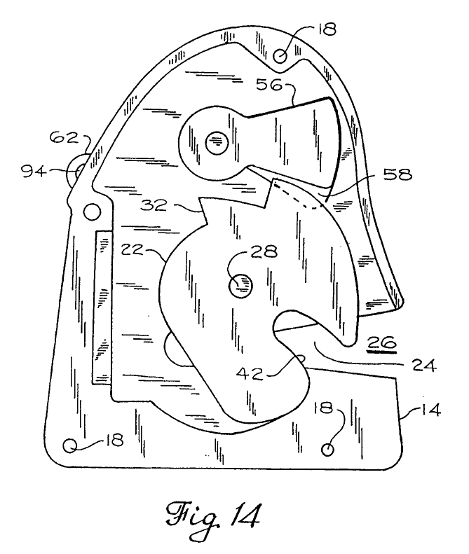

It should be noted that the ratchet 22 is preferably biased into its unlatched position (clockwise as viewed in FIG. 4) by the ratchet spring 40. The latch assembly 10 therefore returns to an unlatched state unless movement of the ratchet 22 is interfered with as will be discussed in more detail below. When the striker 20 is inserted into the grooves 24, 26, 27 of the ratchet 22, the rear mounting plate 14, and the housing 16 in this unlatched position, the striker 20 presses against the lower wall 42 of the groove 24 in the ratchet 22 (see FIG. 14) and thereby causes the ratchet 22 to rotate about the lower pivot post 30 against the compressive force of the ratchet-spring 40 in the stop pin groove 38. Further insertion of the striker 20 rotates the ratchet 22 until the striker 20 contacts and is stopped by the elastomeric element 44 (described below) and/or until the reactive force of the ratchet spring 40 stops the ratchet 22.

Due to the high impact forces commonly experienced by the latch assembly 10 as the striker 20 enters and is stopped by the latch assembly 10, it is desirable to cushion the impact of the striker 20 upon the latch assembly 10 as the striker 20 is stopped. To this end, one well known element preferably used in the present invention is an elastomeric element 44 located behind the termination of the groove 26 in the rear mounting plate 14. The elastomeric element 44, secured in a conventional manner to the rear mounting plate 14 and/or to the housing 16, is an impact absorbing article preferably made of an elastomeric material such as rubber, urethane, plastic, or other resilient material having a low deformation memory.

The elastomeric element 44 not only performs the function of absorbing potentially damaging forces experienced by the latch assembly 10 during striker capture, but also acts to reduce the operational noise emitted by the latch assembly 10. One having ordinary skill in the art will appreciate that a number of other conventional damper and impact absorbing elements and devices can be used in the latch assembly 10 of the present invention to protect the latch assembly 10 from high impact forces and to reduce latch noise. These other damper and impact absorbing elements fall within the spirit and scope of the present invention.

The ratchet 22, the rear mounting plate 14, the elastomeric element 44, and their operational relationship with respect to the striker 20 as described above is generally conventional and well known to those skilled in the art. In operation, prior art latch mechanisms employ one or more elements which interact or interfere with the ratchet 22 at particular positions in its rotation to prevent rotation of the ratchet 22 to its unlatched position once the striker 20 is inserted sufficiently within the latch assembly 10. For example, such elements can be brought into contact with a stop surface 32 of the ratchet 22 when the ratchet 22 is in its latched position (i.e., rotated to a counterclockwise position as viewed in FIG. 4). When it is desired to release the striker 20 in an unlatching procedure, the elements are removed from interference with the ratchet 22 and the ratchet 22 is returned to its unlatched position (e.g., by the ratchet spring 40). As described above in the Background of the Invention, the prior art mechanisms and elements used to selectively insert and remove such elements from the ratchet 22 are virtually always complex, expensive to manufacture, inefficient, and relatively slow.

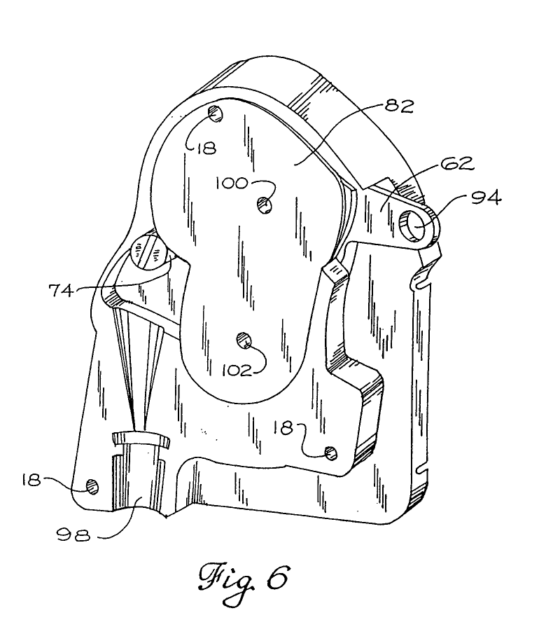

In one preferred embodiment of the present invention, the latch assembly 10 has a pawl 54 as best seen in FIGS. 4-12. The pawl 54 is rotatably mounted upon an upper pivot post 34 extending from the rear mounting plate 14. The upper pivot post 34, like the lower pivot post 30, is preferably attached to the rear mounting plate 14 by fastening, riveting, screwing, bolting, or other conventional fastening methods. The upper pivot post 34 can instead be made integral with the rear mounting plate 14, if desired.

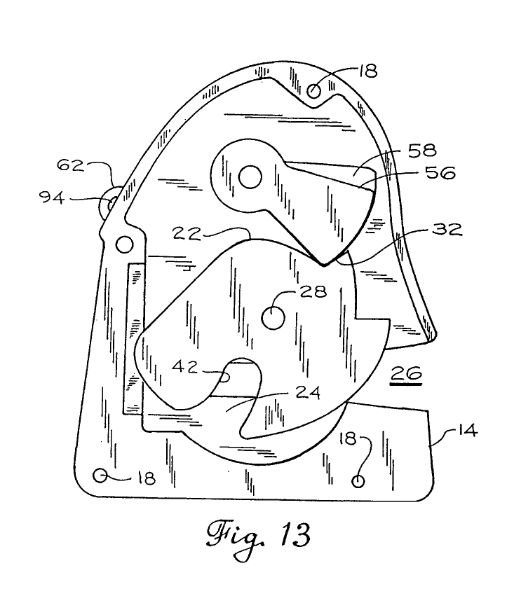

The pawl 54 preferably includes a cam 56 (see FIGS. 5, 13, and 14). The body of the pawl 54 is preferably located on a side of the housing 16 opposite the ratchet 22. However, the cam 56 of the pawl 54 preferably extends through an aperture 58 within the housing 16 to place the cam 56 in selective engagement with the ratchet 22. Specifically, the pawl's fit within the aperture 58 of the housing 16 is loose enough to permit an amount of movement of the cam 56 relative to the ratchet 22. It should be noted that although the housing shape illustrated in the figures is preferred in the present invention, other housing shapes can be used (e.g., having a different aperture type for accepting different pawls 54, cams 56, and different pawl and cam motions, different housing interior shapes and sizes for accepting different control elements and control element motions, etc.). As best shown in FIGS. 13 and 14, the pawl 54 and the cam 56 can preferably be placed in one position (FIG. 13) in which the cam 56 engages with the stop surface 32 of the ratchet 22 when the ratchet 22 is in its latched position and in another position (FIG. 14) in which the cam 56 is retracted from and does not interfere with rotation of the ratchet 22. In the retracted pawl position, the ratchet spring 40 causes the ratchet 22 to automatically rotate to its unlatched position shown in FIG. 14 as described above.

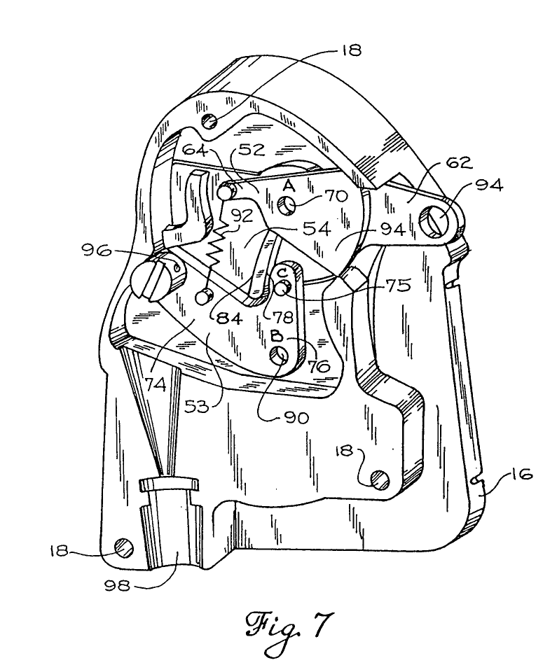

The pawl 54 is preferably biased into its ratchet interfering position by a pawl spring 59. Referring to FIGS. 7-12, it can be seen that the pawl spring 59 is preferably a compression spring contained between walls of the pawl 54 and the housing 16. The pawl spring 59 biases the pawl 54 in a counterclockwise direction as viewed in FIGS. 7-12, thereby pressing the cam 56 toward the ratchet 22 on the opposite side of the housing 16. It will be appreciated that although the pawl spring 59 is shown secured between walls of the pawl 54 and the housing 16, such an arrangement and position is not required to perform the function of biasing the pawl 54 in the counterclockwise direction as viewed in FIGS. 7-12. Indeed, the pawl spring 59 can instead be rigidly attached at one end to a part of the pawl 54, can be rigidly attached to an inside wall of the housing 16, can be contained within walls solely in the pawl 54 or solely in the housing 16 (still permitting, of course, an end of the pawl spring 59 to exert force against the pawl 54 and another end to exert force against the housing 16), and the like. Any such configuration in which the pawl spring 59 is positioned to exert a force against the pawl 54 in a counterclockwise direction as viewed in FIGS. 7-12 can instead be used in the present invention. Such alternative configurations are well known to those skilled in the art and are therefore encompassed within the spirit and scope of the present invention.

The preferred embodiment of the present invention just described also has at least one control element 52. By moving the pawl 54 (e.g., rotating the pawl 54 in the preferred embodiment), the latch assembly 10 can be placed in its unlatched state or can be secured in its latched state by virtue of the pawl's relationship with the ratchet 22. With proper positioning and control of the control element 52, movement of the control element 52 to press and/or ride against the pawl 54 therefore moves the pawl 54 to release the ratchet 22 and thereby to release the striker 20. With different positioning and control of the control element 52, movement of the control element 52 does not impart movement to the pawl 54 and therefore does not release the ratchet 22 to release the striker 20. As will now be described, the control element 52 of the present invention can be positioned and controlled in either manner to define an unlatched state of the latch assembly 10 and a latched state of the latch assembly 10.

Turning to FIGS. 7-12, a highly preferred embodiment of the present invention has a right and a left control element 52, 53, respectively. Once again, the terms “right” and “left” are used only for ease of description, and do not imply that these elements necessarily be in a right and left position with respect to each other or to other elements in the latch assembly 10. Other orientations are possible and fall within the scope of the present invention. The control elements 52, 53 preferably act as levers in the latch assembly 10, and are externally actuatable by a user. However, and as described below in greater detail, the control elements 52, 53 need not necessarily pivot (an inherent part of a lever's operation), but can instead translate and/or translate and rotate in alternate embodiments of the present invention. Therefore, the term “lever” as used herein does not necessarily require that the control elements 52, 53 pivot or exclusively pivot.

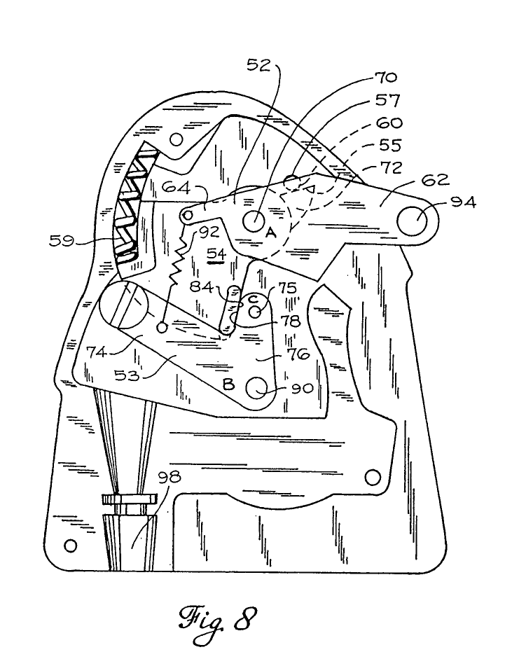

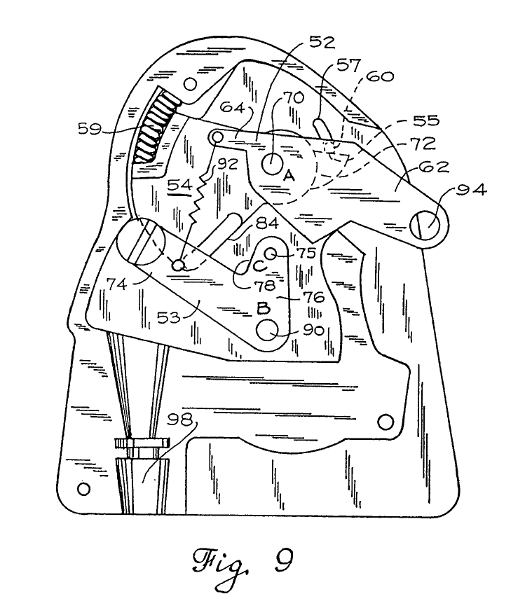

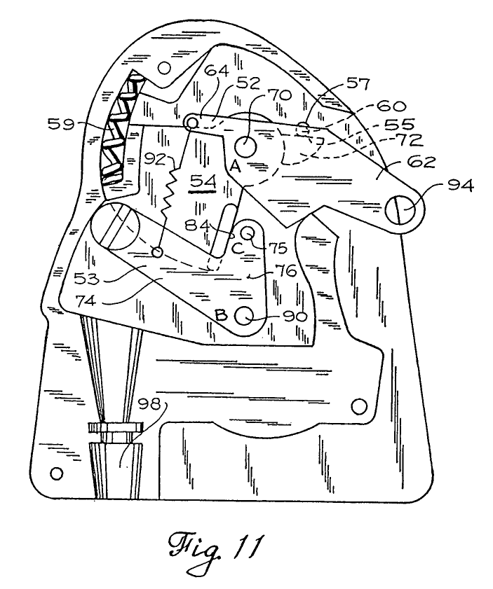

Referring to FIGS. 4 and 7-12, it can be seen that the right control element 52 preferably has a first pivot point A (see FIGS. 8-12), an abutment post 60, a linkage end 62, and a lever end 64 opposite the linkage end 62. The abutment post 60 is preferably in abutting relationship with a ledge 72 of the pawl 54 at a bearing surface 55 of the pawl 54. Therefore, as shown in FIG. 11, when an actuating force is exerted (downwardly) against the linkage end 62 of the right control element 52, the right control element 52 rotates in a clockwise direction about the abutment post 60 which acts as a fulcrum for the right control element 52 and as a bearing surface against the bearing surface 55 of the pawl 54. However, if the right control element 52 is also engaged for rotation about pivot point A, the same actuation force against the linkage end 62 of the right control element 52 rotates the right control element 52 and the pawl 54 together about pivot point A (rather than rotating the right control element 52 about the abutment post 60). In this latter case, the abutment post 60 acts as a bearing surface against the bearing surface 55 of the pawl 54 as the pawl bearing surface 55 is pushed downward. It can thus be seen that by engaging and disengaging the right control element 52 for pivotal movement about pivot point A, actuation of the right control element 52 will either rotate the pawl 54 or not rotate the pawl 54, respectively. FIG. 9 thus defines an unlocked state of the latch assembly 10 (with the right control element 52 engaged for rotation about pivot point A) because rotation of the pawl 54 will cause release of the ratchet 22 and the striker 20 (see FIG. 14). Also, FIG. 11 thus defines a locked state of the latch assembly 10 (with the right control element 52 disengaged from rotation about pivot point A) because the pawl 54 does not rotate with the right control element 52 to release the ratchet 22 and the striker 20 (see FIG. 13). To better control the movement of the right control element 52 either in its locked state or in its unlocked state, highly preferred embodiments of the present invention have a groove 57 in the housing 16 within which the abutment post 60 of the right control element 52 is received (see FIGS. 4 and 5). When the right control element 52 pivots about the abutment post 60, the abutment post 60 rotates in place at the top of the groove 57, held there by the bearing surface 55 of the pawl 54. When the right control element 52 is instead engaged for pivotal movement about pivot point A, the abutment post 60 travels down the groove 57 while it pushes the pawl 54 in a clockwise direction.

With the above relationship between the right control element 52 and the pawl 54 in mind, switching between the locked and unlocked states of the right control element 52 is therefore ultimately dependent upon disengagement and engagement operations, respectively, of the right control element 52 for rotation about pivot point A. Such operations can be performed in a number of ways. The most highly preferred method in the present invention is via a pin 66 (see FIG. 5) selectively retracted and extended by a high-speed actuator 68. When the actuator 68 is placed in its extended position, the pin 66 is preferably inserted into an aperture 70 (see FIGS. 7-12) in the right control element 52 at pivot point A, thereby controlling the right control element 52 to rotate about pivot point A when actuated by a user. When the actuator 68 is placed in its retracted position, the pin 66 is preferably retracted from the aperture 70, thereby permitting the right control element 52 to pivot about the abutment post 60. The arrangement just described therefore reduces the time for placing the control element 52 in its locked and unlocked positions to the time required for disengaging and engaging the right control element 52 with the pin 66. This time can be quite short depending upon the type of actuator 68 used. In contrast to prior art devices which require engagement elements which operate parallel to the plane of motion of the control elements, the engagement elements of the present invention operate perpendicular to the plane of motion of the control elements. This arrangement also reduces the forces required to move the engagement elements. Accordingly, an actuator with a relatively short stroke can be used to place the control elements 52, 53 in their locked and unlocked states, which generally results in a faster motion. In fact, in highly preferred embodiments of the present invention, actuator extension and retraction operations can be completed in under 10 milliseconds. Prior art devices require significantly more time to perform comparable latch assembly operations. Of course, one or more manual actuators can instead be used in the present invention to manually insert the pin 66 or move any other engagement element into engagement with the control elements 52, 53. The actuators described herein and the other major components of the latch assembly 10 are preferably constructed as modules, enabling ready replacement or substitution.

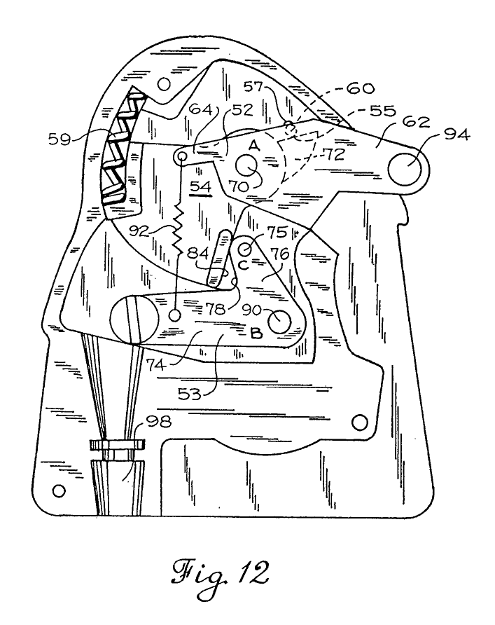

Following along very similar structural and operational principles as the right control element 52, the left control element 53 also has a first pivot point B, a linkage end 74, a lever end 76 opposite the linkage end 74, and a rotation peg 75 defining a second pivot point C. Although the left control element 53 is also preferably a lever, in the preferred embodiment of the present invention shown in the figures, the left control element 53 is L-shaped and preferably has a cam surface 78 located adjacent the pawl 54. Therefore, and as shown in FIG. 12, when an actuating force is exerted (downwardly) against the linkage end 74 of the left control element 53, the left control element 53 preferably rotates in a counterclockwise direction about the rotation peg 75. Accordingly, the left control element 53 does not act upon the pawl 54 during rotation of the left control element 53 about the rotation peg 75 as shown in FIG. 12. To prevent unwanted translational movement of the rotation peg 75 during the counterclockwise rotation of the left control element 53, the rotation peg 75 preferably rests in a groove 80 of the cover plate 82 (see FIGS. 4 and 5). Of course, other well known elements can be used to prevent this translation, such as a ledge or rib extending from the rear surface of the cover plate 82.

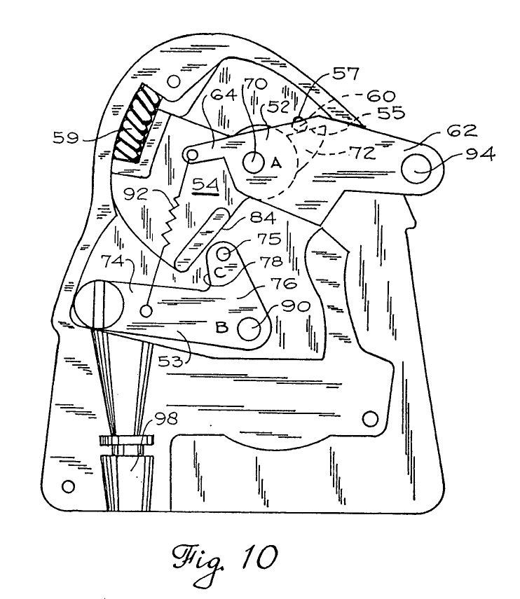

However, if the left control element 53 is engaged for rotation about pivot point B, the same actuation force against the linkage end 74 of the left control element 53 rotates the left control element 53 to press the cam surface 78 of the left control element 53 into a cam surface 84 of the pawl 54, thereby rotating the pawl 54 about the upper pivot post 34. It can thus be seen that by engaging and disengaging the left control element 53 for pivotal movement about pivot point B, actuation of the left control element 53 will either rotate the pawl 54 or not rotate the pawl 54, respectively. FIG. 10 thus defines an unlocked state of the latch assembly 10 (with the left control element 53 engaged for rotation about pivot point B), because rotation of the pawl 54 will cause release of the ratchet 22 and the striker 20. Also, FIG. 12 thus defines a locked state of the latch assembly 10 (with the left control element 53 disengaged from rotation about pivot point B) because the pawl 54 does not rotate under camming force exerted by the left control element 53 to release the ratchet 22 and the striker 20.

As with the right control element 52, switching between the locked and unlocked states of the left control element 53 is therefore ultimately dependent upon disengagement and engagement operations, respectively, of the left control element 53 for rotation about pivot point B. Also as with the right control element 52, the preferred method of performing such operations in the present invention is via a pin 86 (see FIG. 5) selectively retracted and extended by a high-speed actuator 88. When the actuator 88 is placed in its extended position, the pin 86 is preferably inserted into an aperture 90 (see FIGS. 7-12) in the left control element 53 at pivot point B, thereby controlling the left control element 53 to rotate about pivot point B when actuated by a user. When the actuator 88 is placed in its retracted position, the pin 86 is retracted from the aperture 90, thereby controlling the left control element 53 to pivot about its rotation peg 75 when actuated by a user. The arrangement just described therefore reduces the time for placing the left control element 53 in its locked and unlocked positions to the time required for disengaging and engaging the left control element 53 with the pin 86. This time can be quite short depending upon the type of actuator 88 used).

For proper positioning of the right and left control elements 52, 53 within the latch assembly 10, the latch assembly 10 preferably has at least one control element spring 92 (see FIGS. 7-12). In the most preferred embodiment of the present invention, one control element spring 92 is connected in a conventional manner between the ends 64, 74 of the right and left control elements 52, 53, respectively. Preferably, the control element spring 92 is connected to each end 64, 74 by being hooked onto posts formed near the ends 64, 74. However, the control element spring 92 can be fastened to the ends 64, 74 in a number of other well known manners (e.g., via a fastener securing the ends of the spring 92 in place upon the ends 64, 74, via welding, glue, epoxy, etc.). The control element spring 92 acts to bias the control elements 52, 53 toward one another and into their unactuated positions shown in FIG. 8.

One having ordinary skill in the art will recognize that the particular control element spring 92 and its location within the latch assembly 10 shown in the figures is only one of a number of different control element spring types and locations serving this biasing function. For example, two or more control element springs can instead be used to bias the control elements 52, 53 into their unactuated positions. In such a case, the control element springs can be attached between the ends 64, 74 and the housing 16. Alternatively, the control element springs can be of a different form than the extension spring shown in the figures. For example, the control element springs can be coil, torsion, or leaf springs arranged in the latch assembly 10 to bias the control elements 52, 53 as described above. Such alternate biasing elements and arrangements fall within the sprint and scope of the present invention.

Prior to describing the actuators 68, 88 and their operation in more detail, the mechanical actuation of the control elements 52, 53 will now be described. Each control element 52, 53 is provided with a linkage end 62, 74 upon which external forces are preferably exerted to actuate the control elements 52, 53. In the case of the right control element 52, the linkage end 62 is preferably an arm of the right control element 52 having an aperture 94 therethrough at its terminal portion. In the case of the left control element 53, the linkage end 74 is preferably a post having an aperture 96 therethrough. When the latch assembly 10 is installed, an external linking element (not shown) is connected via the aperture 94 to the right control element 52 and an external linking element (also not shown) is connected via the aperture 96 to the left control element 53. Herein and in the appended claims, the terms “linking element” and “input element” are used interchangeably. Because the left control element 53 is preferably located fully within the latch assembly 10, the linking element is passed through a port 98 within the housing 16 and the cover 12 of the latch assembly 10. Of course, the port 98 can take any number of shapes and locations within the housing 16 and/or the cover 12 to permit the external linking element to be connected inside the latch assembly 10 to the left control element 53.

In the highly preferred embodiment of the present invention shown in the figures, the linking element connected in a conventional fashion to the right control element 52 is preferably a bar or member connected and directly actuated by, e.g., a door handle, while the linking element connected to the left control element 53 is preferably a cable which is secured in a conventional fashion to the linkage end 74. The linking element connected to the left control element 53 is preferably passed out of the latch assembly 10 through the port 98. It should be noted that although cables are preferred, other types of linking elements can be used, such as rods, bars, chains, string, rope, etc. In fact, the linking elements can even be made integral to or extensions of the control elements 52, 53 themselves. The particular type of linking element used is dependent at least in part upon the shape, size, and position of opening(s) in the cover 12 and/or the housing 16 to permit the control elements 52, 53 to be connected to the external linking elements. The particular type of linking element used can also depend upon whether attachment of the control elements 52, 53 to the linking elements is accomplished externally of the cover 12 and/or the housing 16 (such as in the case of the right control element 52 shown in the figures) or internally (such as in the case of the left control element).

The latch assembly 10 described above and illustrated in the figures finds particular application for doors having two handles, such as an internal handle and an external handle. In this application, one handle is connected to the right control element 52 and the other handle is connected to the left control element 53 via the linking elements described above. Therefore, actuation of one handle actuates one control element while actuation of the another handle actuates the other control element. The manner of connection of the linking elements to the handles is well known to those skilled in the art and is therefore not described further herein. It should also be noted that the linking elements need not necessarily be attached to door handles. Especially where the latch assembly 10 is used in applications not involving vehicle doors (or indeed, any type of door), the control elements 52, 53 can be actuated either indirectly via linking elements or directly to operate the latch assembly 10. Any number of conventional elements and mechanisms can be linked to the control elements 52, 53 to effect their actuation as desired. As described above, the type of movement of the control elements 52, 53 (when actuated) is dependent upon whether the pins 66, 86 are extended or retracted to engage with the control elements 52, 53. When the pins 66, 86 are extended by the actuators 68, 88 to engage the control elements 52, 53, the control elements 52, 53 preferably pivot about pivot points A and B, respectively, which permits the control elements 52, 53 to exert motive force to the pawl 54. When the pins 66, 86 are retracted by the actuators 68, 88 to disengage from the control elements 52, 53, the control elements 52, 53 preferably pivot instead about abutment post 60 and rotation peg 75, respectively, which prevents the control elements 52, 53 from exerting force upon the pawl 54 sufficient to move (rotate) the pawl 54. Because the speed in which the control elements 52, 53 are placed in their locked and unlocked states is thus dependent upon the speed of the actuators 68, 88 to move the pins 66, 86, it is desirable to use the fastest actuator type economically reasonable for the actuators 68, 88. In the most preferred embodiment of the present invention, the actuators 68, 88 are each a two-position residual magnetic latching electromagnetic solenoid such as those commercially available from and sold by TLX Technologies of Waukesha, Wis. However, other conventional actuator types are possible, including other types of solenoids, conventional hydraulic or vacuum actuators, small motors, and even elements or assemblies which are manually operated to push and retract the pins 66, 86 to place the control elements 52, 53 into their locked and unlocked positions. Though not as preferred as two-position electromagnetic solenoids, these alternative actuators fall within the spirit and scope of the present invention.

The actuators 68, 88 are preferably connected to an electronic control circuit which is controllable by a user for placing the actuators 68, 88 in their engaged and disengaged states, thereby placing the latch assembly 10 in its unlocked and locked states, respectively. Upon command by the user, the electronic control circuit preferably generates electronic pulses to the actuators 68, 88 for controlling their movement. To secure against accidental or unauthorized actuation, a coded signal can be sent to the electronic control circuit. Coding of electronic signals is well known to those skilled in the art and is not therefore discussed further herein. The electronic control circuit can be powered in a conventional manner, such as by a battery, an alternator, a generator, a capacitor, a vehicle electrical system or other conventional power source.

With reference to the preferred embodiment of the present invention, the actuators 68, 88 are electromagnetic solenoids which can retain residual magnetism to hold the actuators 68, 88 in their retracted positions once they are moved thereto. When the actuators 68, 88 are moved to their extended positions, conventional springs (not shown) are preferably used to maintain their positions in the extended states. Therefore, when the actuators 68, 88 are in their retracted positions and held therein via the residual magnetism, a power pulse from the electronic control circuit is used to break the residual magnetism and to thereby extend the actuators 68, 88 via the springs into their extended positions. Conversely, when the actuators 68, 88 are in their extended positions and held therein by the springs, a power pulse from the electronic control circuit is used to force the actuators 68, 88 into their retracted positions against the force of the springs, and residual magnetism is used to keep the actuators 68, 88 in these positions.

In a highly preferred embodiment of the present invention, the electronic control circuit just described contains at least two power sources for the actuators 68, 88 in the latch assembly 10. These power sources can comprise any conventional power sources including, without limitation, capacitors, batteries, alternators, generators and vehicle electrical systems. For illustrative purposes only, a first power source is described herein as a battery and a second power source is described as a capacitor. During normal operation when the latch assembly 10 is powered continuously by the battery 120, each capacitor 124 is continuously charged. Each capacitor 124 stores sufficient energy to break the residual magnetism of the electromagnetic solenoids 68, 88. In the event of total power failure, the control circuit can automatically discharge the capacitors 124 to cause the actuators 68, 88 to unlock the latch assembly 10. The latch assembly 10 can be completely unlocked or partially unlocked upon power failure. When the latch assembly 10 is used on a vehicle door, only the portion of the latch assembly 10 actuated by an inside door handle will be unlocked. This configuration enables the vehicle occupant to exit the vehicle while maintaining security against unauthorized entry. Alternatively, the user can unlock the latch assembly 10 manually (e.g., using a switch) using energy stored by the capacitors. Further, it may instead be desirable to have one capacitor for each actuator 68, 88 with enough charge to place the solenoids 68, 88 in their retracted positions. Therefore, even with power disconnected from the latch assembly 10, there exists sufficient charge in the control circuit to lock the latch assembly 10 (either under command of the user or automatically by the control circuit). With multiple capacitors for each actuator 68, 88, a preferred embodiment of the present invention has one capacitor for each actuator 68, 88 with sufficient energy to place the actuator 68, 88 in its locked position and another capacitor for each actuator 68, 88 with sufficient energy to place the actuator 68, 88 in its unlocked position.

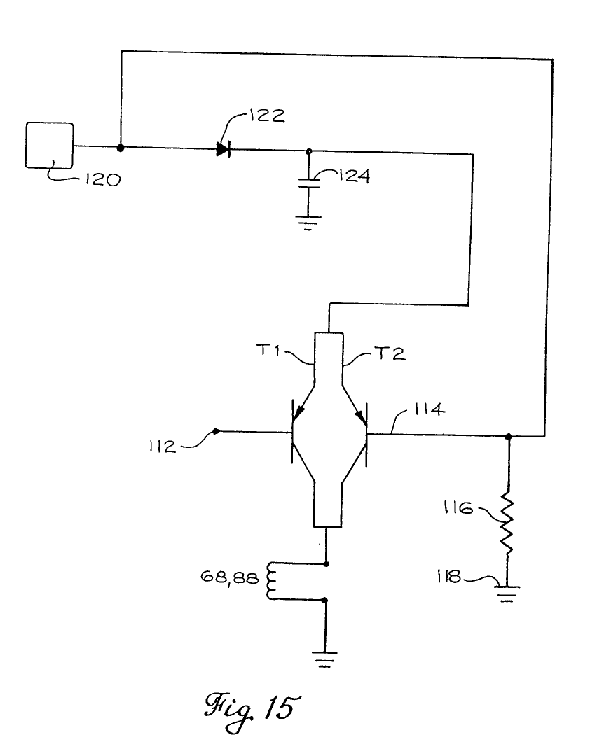

The electronic control circuit is preferably also provided with a conventional electrical characteristic sensing circuit for detecting the power supplied to the electronic control circuit. Such sensing circuits (e.g., voltage or current sensing circuits) are well known to those skilled in the art and are therefore not described further herein except for the generalized example shown in FIG. 15. When the sensing circuit detects a change in an electrical characteristic beyond a predetermined level such as low voltage or current level, or loss of power such as due to a disconnected or failed power source, the control circuit preferably generates a signal to the actuators to place them in their unlocked positions to unlock the latch assembly 10. Alternately, (though not preferred) when the sensing circuit detects the change, the control circuit can instead enable a control or button that can be actuated by the user to unlock the latch.

An exemplary automatic unlocking circuit 110 for unlocking the latch assembly 10 is shown in FIG. 15. It will be apparent to one of ordinary skill in the art that a wide variety of circuits and components different than that illustrated in FIG. 15 and described below can be used equivalently. T1 and T2 are two PNP-type transistors connected in parallel. During typical operation, a delatching pulse applied at node 112 activates transistor T1 and preferably comprises a conventional controlled voltage pulse sufficient to delatch the solenoid 68, 88.

Transistor T2's base 114 is preferably connected to a resistor 116 connected to ground 118, and is also preferably connected to a 12 volt battery or other voltage source 120 such as in a conventional vehicle electrical system.

When 12 volts D.C. from the battery 120 is present, T2 is non-conducting and T1 is non-conducting unless pulsed to ground 118. The diode 122 keeps the capacitor 124 from discharging back to the rest of the system.

Accordingly, the capacitor 124 only discharges when one of the battery's electrical characteristics such as voltage level falls below a predetermined level. When this occurs, the base of T2 approaches ground 118. Therefore, T2 turns on fully and the capacitor 124 can discharge through T2 and send a release pulse through the solenoid 68, 88 thereby delatching the solenoid 68, 88 and unlocking the latch assembly 10.

In addition to all of the preferred embodiments previously described, it will be appreciated by one having ordinary skill in the art that the particular arrangement and operation of the actuators 68, 88 described above for the most preferred embodiment of the present invention can take a number of other forms within the spirit and scope of the present invention. For example, the residual magnetism exerted upon the actuators 68, 88 to keep them in their retracted positions can instead be exerted upon the actuators 68, 88 to keep them in their extended positions, and the springs keeping the actuators 68, 88 in their extended positions can instead be used to keep the actuators 68, 88 in their retracted positions (i.e., the opposite solenoid arrangement as that described above). In such an arrangement, the latch assembly can operate in a similar manner as described above, with a dual power source (e.g., battery and capacitor), with a sensing circuit, and/or with similar electronic circuitry. Such an arrangement can be particularly useful in applications where it is desirable to place or keep the latch assembly 10 in its locked state in the event of power loss. When power is lost, interrupted, or otherwise changed in a predetermined manner, the sensing circuit preferably triggers the actuators to retract using the dual power source arrangement described above, thereby placing the latch assembly in its locked state.

Other embodiments of the present invention employ conventional solenoids using permanent magnets. These magnets retain the solenoid's armatures in both extended and retracted positions as is well known in the art. Other well known systems and elements can be used to achieve the function of the capacitors described above, and well known mechanical and electrical systems and elements can be used as alternatives to the springs and residual magnetism employed to control the positions of the actuators 68, 88.

As indicated above, many alternatives to the use of electromagnetic solenoids for the actuators 68, 88 exist and are well known to those skilled in the art. For example, the actuators can each be a rack and pinion assembly. As another example, the actuators can each be a motor turning a worm gear that meshes with an element (e.g., a threaded pin) to push and pull the element toward and away from the control elements 52, 53. The element can instead be a wheel having teeth meshing with the worm gear. In such an arrangement, rotation of the worm gear causes rotation of the wheel. A pin or rod attached to the circumference of the wheel can then be moved toward or away from the control elements 52, 53 via rotation of the wheel. All other well known mechanisms for quickly extending and retracting a pin or other engagement element are useful with and fall within the spirit and scope of the present invention.

The actuators 68, 88 in the preferred embodiment of the present invention are preferably contained and substantially enclosed in the cover 12 and are preferably encapsulated therein by the cover plate 82 as best shown in FIGS. 46. The cover plate 82 is preferably provided with apertures 100, 102 for receiving the pins 66, 86, respectively, which extend beyond the cover plate 82 when in their extended positions to interact with the control elements 52, 53. The cover plate 82 also helps to protect the actuators 68, 88 from debris, dirt, etc., managing to enter the latch assembly 10 between the cover plate 82 and the housing 16, and helps to control movement of the pins 66, 86.

The pins 66, 86 are preferably mounted to or integral with the armatures of the actuators 68, 88. It will be apparent to one of ordinary skill in the art that the pins 66, 86 need not necessarily be mounted to or be part of the armatures. Instead, the pins can be mounted to pin plates 104, 106 as shown in the figures. Further, depending largely upon the type of actuator used, the pins 66, 86 can extend within the actuators 68, 88 which directly control the movement of the pins 66, 86 into and out of the apertures 100, 102 in the cover plate 82. Other pin arrangements will be recognized by those skilled in the art and are encompassed by the present invention.

In operation, the user of the preferred embodiment of the present invention described above has the ability to select from four locking modes of the latch assembly 10: unlocked, locked, child locked, and dead locked. In the unlocked mode, the electronic control circuit described above preferably sends a signal or signals to both actuators 68, 88 to place them in their extended positions in which the pins 66, 86 are also in their extended positions. The pins 66, 86 thus interact with the control elements 52, 53 to control the control elements 52, 53 to pivot about pivot points A and B. By pivoting about pivot points A and B, the control elements 52, 53 are able to move the pawl 54 and release the ratchet 22 to unlatch the latch assembly 10 when the control elements 52, 53 are actuated by a user. In this unlocked state, actuation of either control element 52, 53 (e.g., via the inside door handle or the outside door handle of a vehicle door) will therefore unlatch the latch assembly 10.

In the locked mode, the electronic control circuit preferably sends a signal or signals to one of the two actuators 68, 88 to place it in its retracted position and a signal or signals to the other actuator 88, 68 to place it in its extended position. In the case of the latch assembly 10 illustrated in the figures, the upper actuator 68 controls the position of the upper pin 66 which is either engaged or disengaged with the right control element 52, while the lower actuator 88 controls the position of the lower pin 86 which is either engaged or disengaged with the left control element 53. While the control elements 52, 53 can be connected directly to door handles, the right control element 52 is preferably coupled by a linking element to the outside door handle while the left control element 53 is preferably coupled by a linking element to the inside door handle. The linking elements can comprise conventional linkages, rods, cables, linear actuators, rotary actuators and the like for transmitting torque, tensile forces and/or compressive forces. Thus, for the arrangement just described, the upper actuator 68 controls the locked and unlocked states of the outside door handle, and the lower actuator 88 controls the locked and unlocked states of the inside door handle.

Prior to describing the child locked mode of the latch assembly 10, it should be noted that the term “child locked” is used herein for mode identification purposes only. The term itself is not intended to explicitly or implicitly define the arrangement and operation of the latch assembly 10. In general use of the term, “child locked” typically means that the inside door handle of a vehicle door is not operable to unlatch the door, and does not provide any information about the operability of the outside door handle. However, for mode identification purposes herein, the term “child locked” means that the inside door handle is inoperable and the outside door handle is operable.

In the child locked mode for the particular arrangement of the latch assembly 10 described above, the upper actuator 68 is preferably in an extended position (controlled by the electronic control circuit) and the upper pin 66 is engaged with the right control element 52. The right control element 52 is therefore in its unlocked state. The lower actuator 88 is preferably in a retracted position (also controlled by the electronic control circuit) and the lower pin 86 is disengaged from the left control element 53. The left control element 53 is therefore in its locked state. Actuation of the inside door handle then causes the left control element 53 to move, but not in a manner imparting motive force to the pawl 54 to unlatch the latch assembly 10. Actuation of the outside door handle causes the right control element 52 to pivot about pivot point A (engaged via the upper pin 66), thereby moving the pawl 54 to unlatch the latch assembly 10. Therefore, in the child locked mode, the latch assembly 10 can be unlatched by the outside door handle but not by the inside door handle. It should be noted, however, that the outside door handle can be put into a locked state independent of the child locked mode.

In the dead locked mode, the electronic control circuit preferably sends a signal or signals to both actuators 68, 88 to place them in their retracted positions in which the pins 66, 86 are also in their retracted positions. The pins 66, 86 thus do not interact with the control elements 52, 53, leaving the control elements 52, 53 to pivot about the abutment post 60 and the rotation peg 75, respectively. By pivoting about the abutment post 60 and the rotation peg 75, the control elements 52, 53 are unable to move the pawl 54 and release the ratchet 22 to unlatch the latch assembly 10 when the control elements 52, 53 are actuated by a user. In this dead locked state, actuation of either control element 52, 53 (e.g., via the inside door handle or the outside door handle of a vehicle door) will therefore not unlatch the latch assembly 10.

It will be appreciated by one having ordinary skill in the art that the principles of the present invention can be practiced with latch assemblies which are arranged in a significantly different manner than the preferred embodiment of the latch assembly 10 described above and illustrated in the drawings. Specifically, the connection of the upper actuator 68, upper pin 66, and right control element 52 to an outside door handle and the connection of the lower actuator 88, lower pin 86, and left control element 53 to an inside door handle can be reversed (i.e., the upper actuator 68 controlling the locked and unlocked states for the inside door handle and the lower actuator 88 controlling the locked and unlocked states for the outside door handle). In fact, the use of two actuators 68, 88, two pins 66, 86, and two control elements 52, 53 is only a preferred embodiment. More or fewer actuator, pin, and control element sets can be used depending upon the number of handles (or other user-actuated elements) desired to control the various locking modes of the latch assembly 10. For example, one set can be used if the door only has one handle for latching and unlatching the latch assembly 10. Also, multiple handles (or other user-actuated elements) can be coupled to the same control element, if desired. In such a case, an inside and an outside handle can operate always in the same mode: locked or unlocked.

The cover 12, housing 16, and cover plate 82 of the latch assembly 10 are preferably made of plastic. However, the cover 12, the housing 16, and the cover plate 82 can be made from any number of other materials, such as steel, aluminum, iron, or other metals, urethane, fiberglass or other synthetic materials, composites, refractory materials such as glass, ceramic, etc., and even relatively unusual materials such as wood or stone. Depending upon the type of material used, the cover 12 can be made in a number of manners, such as via a heat and/or pressure sintering process, casting, injection or other molding, curing, extruding, stamping, pressing, firing, welding, etc. The materials and methods just described are well known to those skilled in the art and are encompassed by the present invention.

The rear mounting plate 14, ratchet 22, and pawl 54 are preferably made of steel, and the right and left control elements 52, 53 are preferably made of a castable or moldable material such as zinc or plastic. However, these elements can also be made from a variety of other materials including those noted by way of example in the preceding paragraph. Preferably, the ratchet spring 40, the pawl spring 59, the control element spring 92, and the actuator springs (not shown) are each helical springs made of spring steel. However, one having ordinary skill in the art will recognize that any type of bias member capable of exerting motive force against the relevant elements can instead be used. Such other bias members include, without limitation, an elastomeric material such as rubber, urethane, etc. capable of storing and releasing an amount of force under pressure, magnets, fluid or gas-actuated diaphragms pressing against or pulling the device to be moved, vacuum or suction devices acting upon the element desired to be moved, electromagnets, electrical circuits or elements capable of generating a biasing force, etc. Of course, other spring types (such as conventional coil, torsion, or leaf springs) made from different spring materials can be used in lieu of the helical springs to accomplish the same functions. Although the manners in which the other types of bias members are fastened within the latch assembly can be quite different to create the same or similar biasing force described above, such other types of bias members fall within the spirit and scope of the present invention.

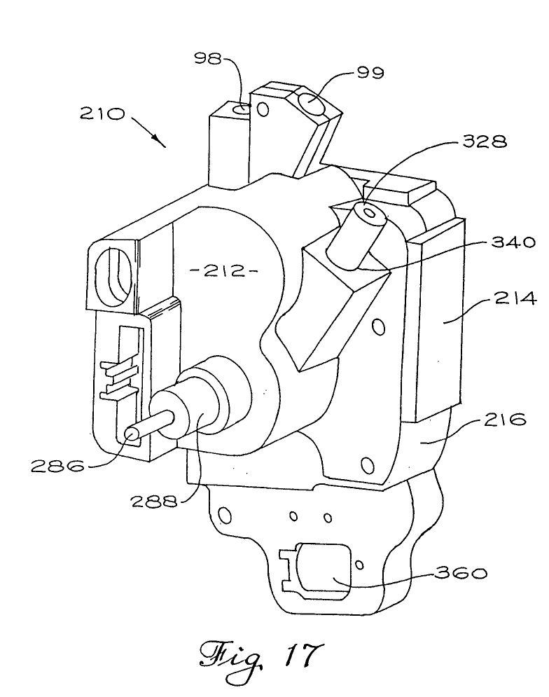

A second preferred embodiment of the present invention is illustrated in FIGS. 17-31. The latch assembly illustrated in FIGS. 17-31 operates on very similar principles to the latch assembly of the first preferred embodiment described above and illustrated in FIGS. 1-15. Elements of the second preferred embodiment which are comparable or which perform functions similar to those in the first preferred embodiment are therefore numbered in like manner in the 200 and 300 series. While the structure and operation of the latch assemblies in the first and second embodiments are substantially the same in many ways, the important structural and operational differences are described in detail below.

The latch assembly of the second preferred embodiment is designed for increased application flexibility and improved modularity. As will be described in greater detail below, the latch assembly 210 is well-suited for installation in a wide number of different door applications and can be used in applications where only limited latch functions are needed as well as in applications where full latch functionality is desired.

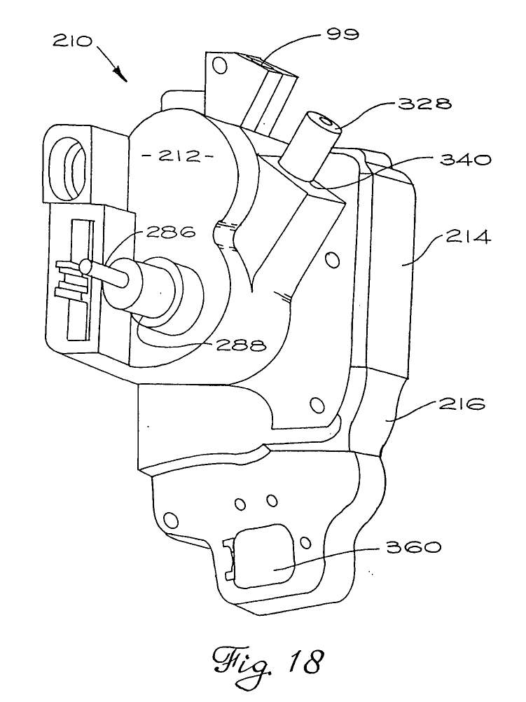

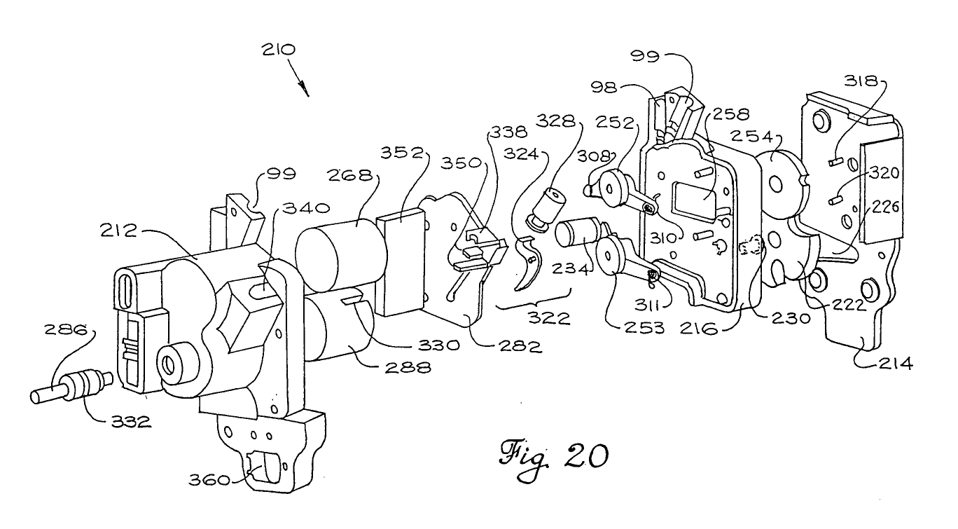

With reference first to FIGS. 17-21, the latch assembly 210 preferably has a housing 216 sandwiched between a rear mounting plate 214 and a front cover 212 in much the same way as the latch assembly 10 of the first preferred embodiment. As can be seen in FIGS. 20-23, a circuit board 352 powered and capable of controlling the actuators 268, 288 in a conventional manner is preferably mounted upon the latch assembly 10, and is more preferably mounted to the front cover 212. With reference also to FIGS. 17 and 18, the latch assembly 210 can also have an aperture 360 for receiving a door ajar switch module (not shown), if desired. The aperture 360 is preferably located in the front cover 212 of the latch assembly 210, but can be located in another area of the latch assembly 210. The latch assembly 210 also preferably has two control elements 252, 253 movable within the housing 216 in two states (one in which actuators 268, 288 drive pins 266, 286 into apertures 270, 290 for control element rotation therearound and one in which the pins 266, 286 are not in the apertures 270, 290 and in which the control elements 252, 253 rotate in a different manner).

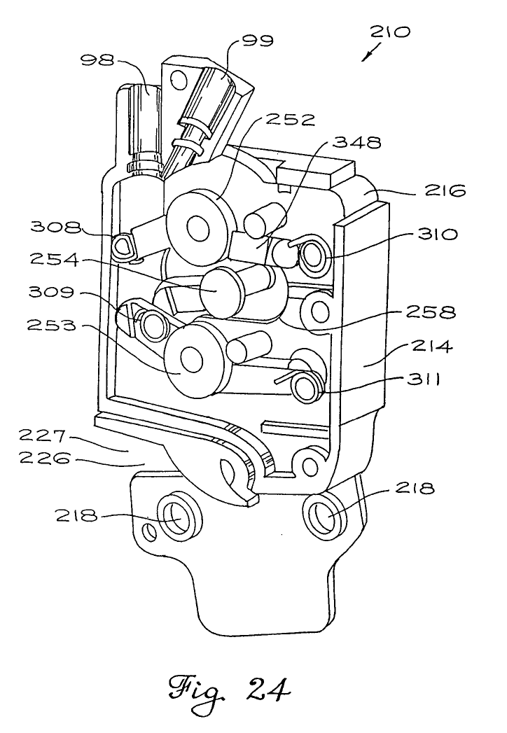

The control elements 252, 253 of the second preferred embodiment are shaped differently than those of the first preferred embodiment. However, each control element 252, 253 preferably still has a linkage end 262, 274, a lever end 264, 276, and an aperture 270, 290 for removably receiving a pin 266, 286 of an actuator 268, 288 therein. Each control element 252, 253 is preferably connected to the housing 216 by at least one torsion spring as shown in FIGS. 24-29. More preferably, the linkage ends 262, 274 and the lever ends 264, 276 of the control elements 252, 253 are each connected to the housing 216 by torsion springs 308, 309, 310, and 311, respectively. Most preferably, each torsion spring 308, 309, 310, 311 has an arm which is received within an groove, hole, slot, or other aperture in the respective linkage end or lever end of the control elements 252, 253, and an arm which is received within a groove, hole, slot, or other aperture in the housing 216. The torsion springs 308, 309, 310, 311 function to connect the control elements 252, 253 to the housing 216 and also to resiliently retain the rotational positions of the control elements 252, 253 as will now be discussed.

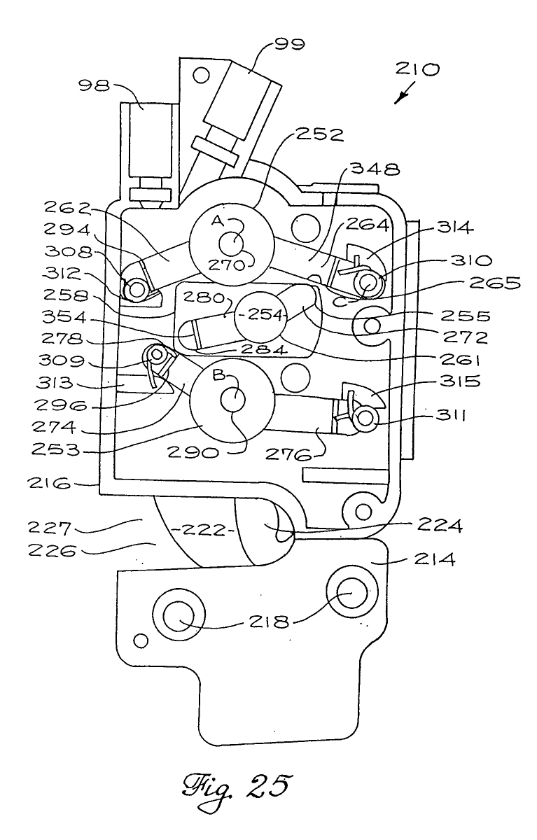

FIG. 25 of the second preferred embodiment shows both control elements 252, 253 in their at rest positions (not actuated). To assist in locating the control elements 252, 253 in these positions, the housing 216 is preferably provided with a number of stops 312, 313, 314, 315 which abut the ends 262, 274, 264, 276 of the control elements 252, 253 when the control elements 252, 253 are drawn to their at-rest positions by their torsion springs 308, 309, 310, 311. The stops 312, 313, 314, 315 are preferably curved walls shaped to match the curved ends of the control elements 252, 253, but can instead be any element (whether integral to the housing 216 or attached thereto in any conventional manner) or elements of sufficient size and strength to stop movement of the control elements 252, 253 under spring force by the torsion springs 308, 309, 310, 311. For example, such elements can instead be studs, posts, blocks, pins, and the like extending from the surface of the housing 216, laterally from the sides of the housing 216, from the rear side of the cover plate 282, etc.

One having ordinary skill in the art will appreciate that many other biasing elements can be used in place of torsion springs 308, 309, 310, 311 to bias the control elements 252, 253 to their at-rest positions. For example, extension, compression, leaf, or other types of springs in the latch assembly can bias the control elements 252, 253 into their at-rest positions. With reference to the discussion above regarding alternative bias elements in the first preferred embodiment of the present invention, still other bias elements can be used in place of the torsion springs 308, 309, 310, 311.

The bias elements (i.e., torsion springs) used to bias the control elements 252, 253 into their at-rest positions can be connected in a number of different manners well known to those skilled in the art. For example, each bias element can be connected at one end to an end of a control elements 252, 253 and to another end at a stop 312, 313, 314, 315 as shown in the figures, to the face of the housing 216, to the rear face of the cover plate 282, and the like. As another example, torsion springs can be fitted about the central portion of the control elements 252, 253 and be attached at one end to the housing 216 or to the cover plate 282 to resist clockwise motion of the control elements 252, 253. Although it is preferable to insert the ends of the springs into holes, grooves, slots or other apertures as shown in the figures, several well-known spring arrangements do not require any spring-receiving element in which to insert the spring ends. For example, the spring ends can wrap around posts or studs on the housing 216 and control elements 252, 253, can be attached to the housing 216 and control elements 252, 253 in any conventional manner (e.g., via welding, gluing, riveting, bolting, and the like), etc.

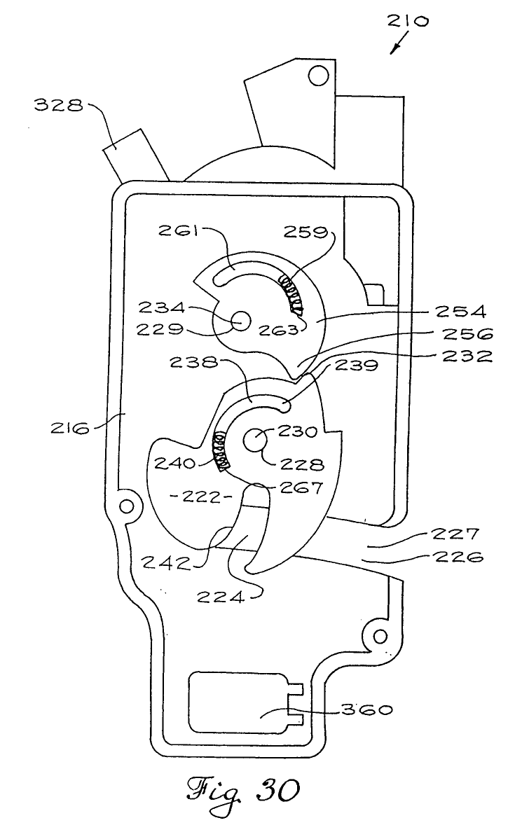

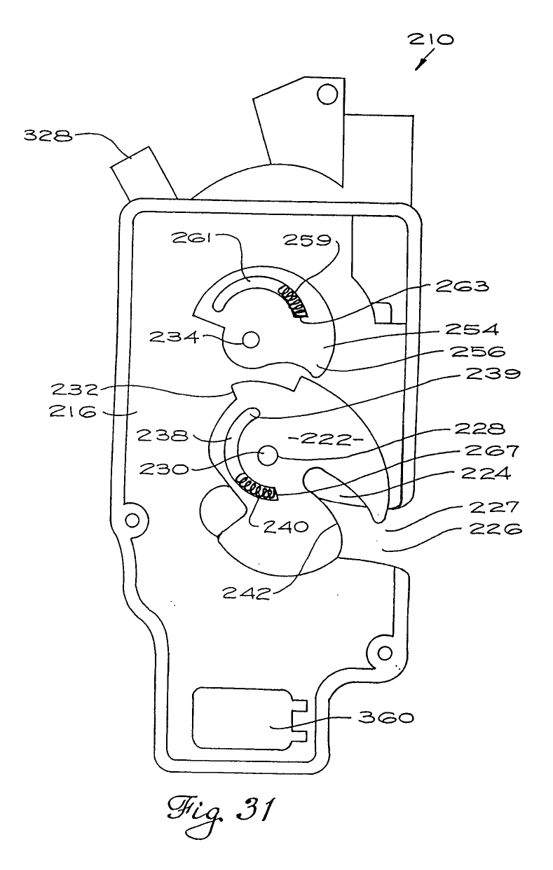

The pawl 254 of the second preferred embodiment also differs from the first preferred embodiment in a number of ways which will now be described. With the exception of the differences described below and illustrated in the drawings, however, additional information regarding the material, operation, and structure of the pawl 254 is set forth above in the description of the first preferred embodiment. As best seen in FIGS. 24-31, the portion of the pawl 254 located on the same side of the housing 216 as the control elements 252, 253 (the “actuation portion” of the pawl 254) preferably has an elongated shape with a lever arm 272 and a linkage arm 280 extending from a central portion 261. The pawl 254 is preferably rotatably mounted upon the upper pivot post 234 which preferably passes through an aperture 229 in the central portion 316 of the pawl 254. The pawl 254 preferably extends through to the opposite side of the housing 216 as best seen in FIGS. 30 and 31. The rear portion of the pawl 254 (the “locking portion” of the pawl 254) shown in FIGS. 30 and 31 is very similar to the rear portion of the pawl 54 in the first preferred embodiment described above and illustrated in FIGS. 13 and 14. However, the pawl 254 has a groove 261 therein in which is retained a pawl spring 259 for biasing the pawl 254 in a clockwise direction into engagement with the ratchet 222 as best shown in FIG. 30. Preferably, a pawl spring pin 318 (see also FIG. 20) or like element extends from the rear mounting plate 214 and into the groove 261 to act against the pawl spring 259. Under compression between the end 263 of the groove 261 and the pawl spring pin 318, the pawl spring 259 acts to bias the pawl 254 in a clockwise direction as noted above. It should be noted that the groove 261, pawl spring 259, and the pawl spring pin 318 can be located on the side of the pawl 254 opposite that shown in the figures, if desired (i.e., the groove 261 and pawl spring 259 facing the housing 216, and the pawl spring pin 259 extending into the groove 261 from the housing 216). As mentioned in the description of the first preferred embodiment, numerous other biasing elements can be used and located in a number of different locations to achieve the pawl biasing function of the pawl spring 259 in the pawl groove 261. Such other elements and locations fall within the spirit and scope of the present invention.

With continued reference to FIGS. 30 and 31, the ratchet 222 of the second preferred embodiment is very similar to the ratchet 22 of the first preferred embodiment. Therefore, with the exception of the differences described below, additional information regarding the material, operation, and structure of the ratchet 222 is set forth above in the description of the first preferred embodiment. Like the ratchet 22 of the first preferred embodiment, the ratchet 222 is rotatably mounted to the lower pivot post 230 (which can be integral or connected to either the rear face of the housing 216 or to the rear mounting plate 214). However, the ratchet 222 is biased in the counter-clockwise direction as viewed in FIGS. 30 and 31 by a ratchet spring 240 seated within a groove 238 in substantially the same manner as the pawl 254 biased by the pawl spring 259. Preferably, a ratchet spring pin 320 (see also FIG. 20) or like element extends from the rear mounting plate 214 into the groove 238 to act against the ratchet spring 240. Under compression between the end 267 of the groove 238 and the ratchet spring pin 320, the ratchet spring 240 acts to bias the ratchet 222 in a counter-clockwise direction as noted above. It should be noted that the groove 238, ratchet spring 240, and the ratchet spring pin 320 can be located on the side of the ratchet 222 opposite that shown in the figures, if desired (i.e., the groove 238 and ratchet spring 240 facing the housing 216, and the ratchet spring pin 320 extending into the groove 238 from the housing 216). As mentioned in the description of the first preferred embodiment, numerous other biasing elements can be used and located in a number of different locations to achieve the ratchet biasing function of the ratchet spring 240 in the ratchet groove 238. Such other elements and locations fall within the spirit and scope of the present invention.

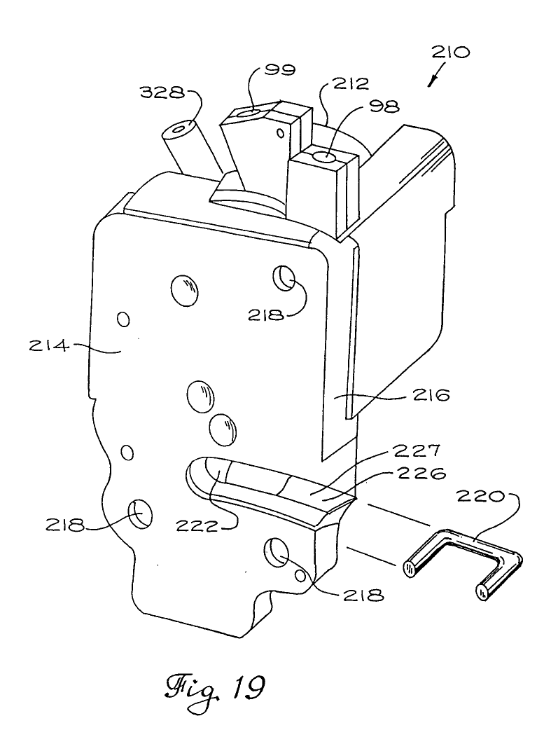

With the above-described differences in the structure and operation of the pawl 254 and the ratchet 222 noted, the general operation of the pawl 254 and the ratchet 222 is preferably substantially the same as that described above with reference to the first preferred embodiment of the present invention. Specifically, and with additional reference to FIG. 19, when the striker 220 is trapped in the ratchet groove 224 in the position shown in FIG. 30, the ratchet spring 240 biases the ratchet 222 in a counter-clockwise direction to release the striker 220. However, the pawl spring 259 biases the pawl 254 into a clockwise direction to engage the cam 256 of the pawl 254 with the stop surface 232 of the ratchet 222, thereby preventing the ratchet 222 from rotating. The pawl and ratchet positions shown in FIG. 30 are therefore their respective locked positions. When the pawl 254 is caused to rotate counter-clockwise by a control element 252, 253 as described in more detail below, the pawl 254 releases the ratchet 222 to rotate counter-clockwise and to release the striker 220. The positions of the pawl 254 and the ratchet 222 in their respective unlatched states (in which the striker 220 is released) are shown in FIG. 31.

Another significant difference between the latch assemblies of the first and second preferred embodiments is the location and arrangement of the linking elements to the control elements 252, 253 (see FIG. 25). As noted in the discussion of the first preferred embodiment above, it is possible to connect external linking elements to the control elements in a number of different ways. The first preferred embodiment illustrated one control element 52 which is connectable to a linking element (not shown) via an aperture 94 at its linkage end 62, and a second control element 53 connectable to a linking element (also not shown) via a post with an aperture 96 therethrough dimensioned to receive an end of the linking element. Rather than have one connection point for a linking element outside of the housing 216 and one connection point for a linking element inside the housing 216 as in the first preferred embodiment, the second preferred embodiment has linkage ends 262, 274 of the control elements 252, 253 both inside the latch housing 216. Preferably, the linkage elements connected thereto are bowden cables (not shown) passed through ports 98, 99 respectively. The linkage elements are preferably received within grooves 294, 296 in the linkage ends 262, 274, but can instead be attached to the linkage ends in any conventional manner.

Unlike the first preferred embodiment, the upper control element 252 of the preferred embodiment is preferably associated with the inside handle of a door, while the lower control element 253 is preferably associated with the outside handle. Therefore, the linking element (e.g., a bowden cable) coupled to the linkage end 262 of the upper control element 252 preferably extends to and is actuatable by an inside door handle, and the linking element (e.g., also a bowden cable) coupled to the linkage end 274 of the lower control element 253 preferably extends to and is actuatable by an outside door handle. In operation of the preferred illustrated embodiment, the upper control element 252 is actuated by pulling upward on the linking element passing through port 98, and the lower control element 253 is actuated by pulling upward on the linking element passing through port 99. The reaction by the control elements 252, 253 to such actuation will now be discussed in detail.

As mentioned above, each control element 252, 253 preferably has two states of operation: a first state in which the control element 252, 253 is engaged with a pin 266, 286 by an actuator 268, 288, and a second state in which the control element 252, 253 is not engaged. The motion of the control elements 252, 253 when actuated differs between the first and second states. Preferably, the control elements 252, 253 pivot about the respective pins 266, 286 when actuated in the first state, but pivot about different pivot points when actuated in the second state.

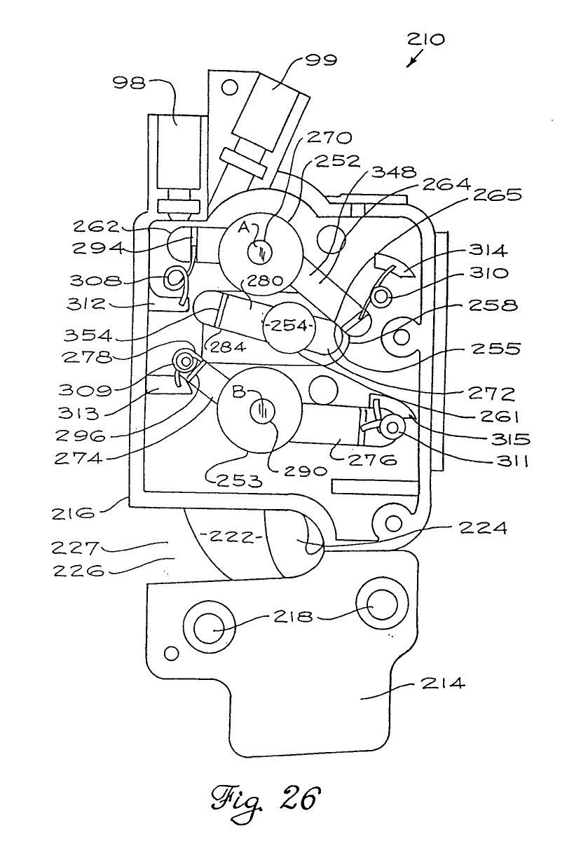

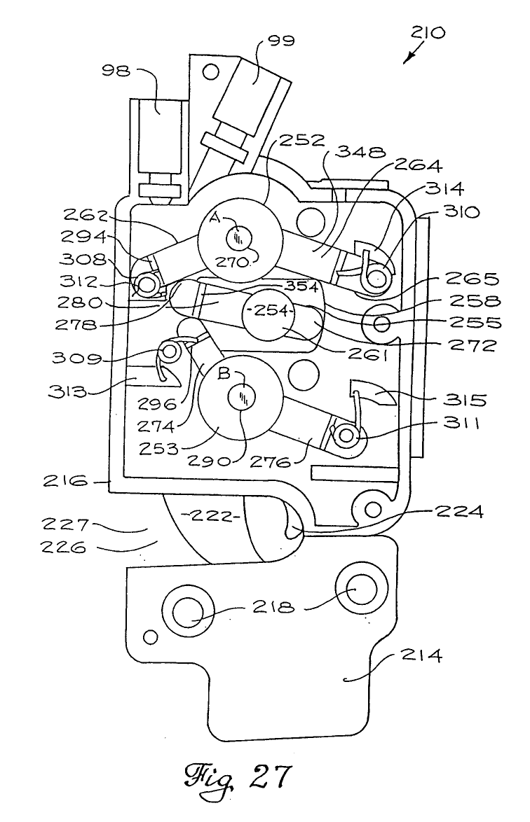

In the first state of the upper control element 252, the pin 266 is driven into the aperture 270 in the upper control element 252 so that actuation of the upper control element 252 will create rotational movement of the upper control element 252 about the pin 266. With reference to FIG. 26, such rotational movement (e.g., via upward actuation of a bowden cable passing through port 98 and connected to the linkage end 262 of the upper control element 252) causes the lever arm 264 of the upper control element 252 to move through a first path of motion in a downward direction until the cam surface 265 of the upper control element 252 contacts and moves in camming contact against the cam surface 255 of the pawl 254. This action pushes the lever arm 272 of the pawl 254 in a downward direction, causing the pawl 254 to rotate in a clockwise direction as shown in FIG. 26 which in turn releases the pawl 254 from the ratchet 222 and unlatches the latch. Therefore, this is the unlocked state of the upper control element 252. Similarly, in the first state of the lower control element 253, the pin 286 is driven into the aperture 290 in the lower control element 253 so that actuation of the lower control element 253 will create rotational movement of the lower control element 253 about the pin 286. With reference to FIG. 27, such rotational movement (e.g., via upward actuation of a bowden cable passing through port 99 and connected to the linkage end 274 of the lower control element 253) causes the linkage end 274 of the pawl 254 to move through a first path of motion an upward direction until the cam surface 278 of the lower control element 253 contacts and moves in camming contact against the cam surface 284 of the pawl 254. This action pushes the linkage arm 280 of the pawl 254 in an upward direction, causing the pawl 254 to rotate in a clockwise direction as shown in FIG. 27 which in turn releases the pawl 254 from the ratchet 222 and unlatches the latch. Therefore, this is the unlocked state of the lower control element 253.

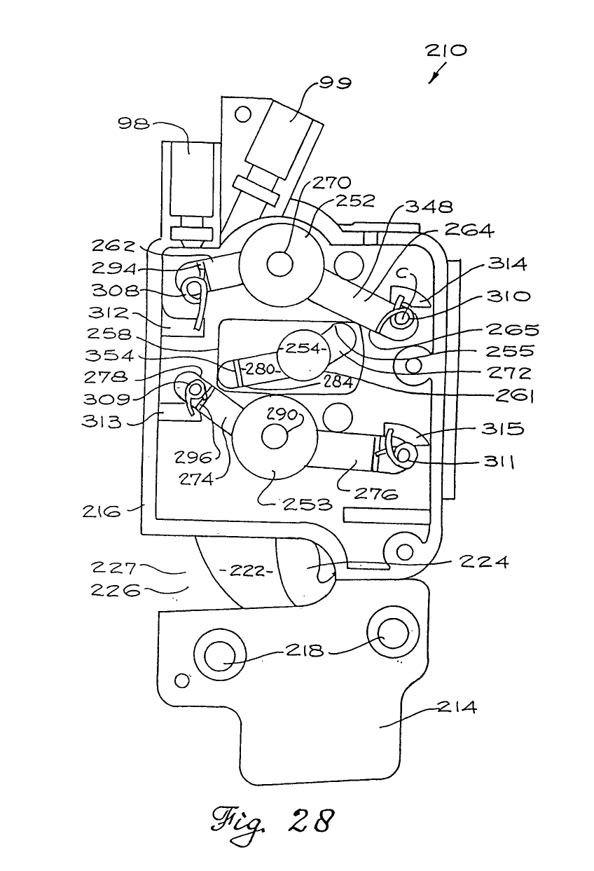

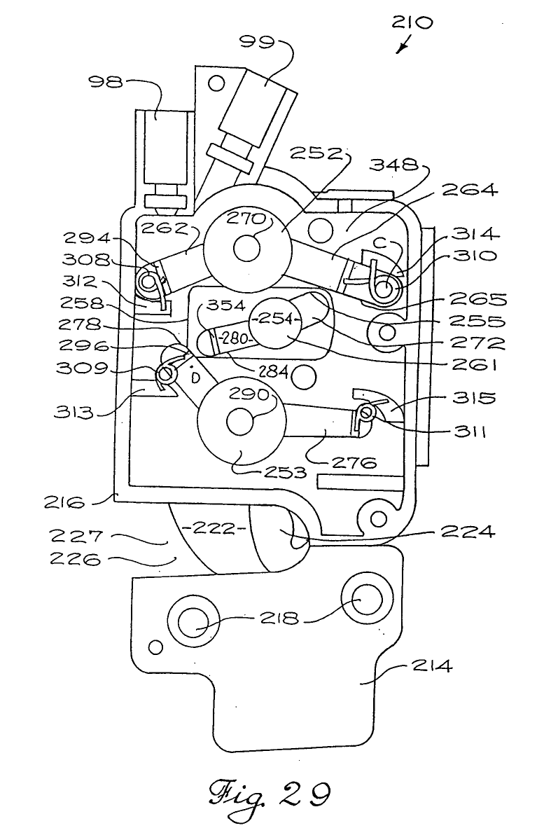

In the second state of the upper control element 252, the pin 266 is released from engagement in the aperture 270 of the upper control element 252. With reference to FIG. 28, actuation of the upper control element 252 (e.g., via upward actuation of a bowden cable passing through port 98 and connected to the linkage end 262 of the upper control element 252) causes the upper control element 252 to rotate about point C near the torsion spring 310 biasing the lever end 264 of the upper control element 252 against its associated stop 314. The upper control element 252 therefore passes through a second path of motion different from the first path described above. In this second path of motion, the upper control element 252 does not move the pawl sufficiently to release the ratchet 222 and to unlatch the latch. Therefore, this is the locked state of the upper control element 252. Most preferably, and as shown in FIG. 28, the upper control element 252 does not contact the pawl 254 in the second path of motion. In the second state of the lower control element 253, the pin 286 is released from engagement in the aperture 290 of the lower control element 253. With reference to FIG. 29, actuation of the lower control element 253 (e.g., via upward actuation of a bowden cable passing through port 99 and connected to the linkage end 274 of the lower control element 253) causes the lower control element 253 to rotate about point D near the cam surface 278 of the lower control element 253 (see FIG. 29). The lower control element 253 therefore passes through a second path of motion different from its first path described above. The lower control element 253 in this second path of motion does not move the pawl 254 sufficiently to release the ratchet 222 and to unlatch the latch. Therefore, this is the locked state of the lower control element 253. Most preferably, and as shown in FIG. 29, the lower control element 253 does not contact the pawl 254 in the second path of motion.

The above-described control element and pawl movement is one manner in which the control elements 252, 253 can be positioned beside a pawl 254 so that their movement in one state causes sufficient movement of the pawl 254 to release the ratchet 222, while their movement in another state causes no movement (or at least insufficient movement) of the pawl 254. This movement has been described above and illustrated as camming movement against the pawl 254. However, it should be noted that a camming relationship between the control elements 252, 253 and the pawl 254 is only one manner in which to transfer motion from the control elements 252, 253 to the pawl 254. Such motion can be transferred in many different ways well-known to those skilled in the art. For example, this motion can be transferred by camming, riding, pushing, or otherwise exerting motive force upon a third element which reacts by moving the pawl 254, by repelling magnetic force between magnets located at or near the locations of the cam surfaces 255, 284, 265, 278 of the pawl 254 and the control elements 252, 253, by directly or indirectly linking the control elements 252, 253 to the pawl 254, and the like. These other manners in which to transmit motive force from the control elements 252, 253 to the pawl 254 (when engaged by the engagement elements 266, 286) fall within the spirit and scope of the present invention.

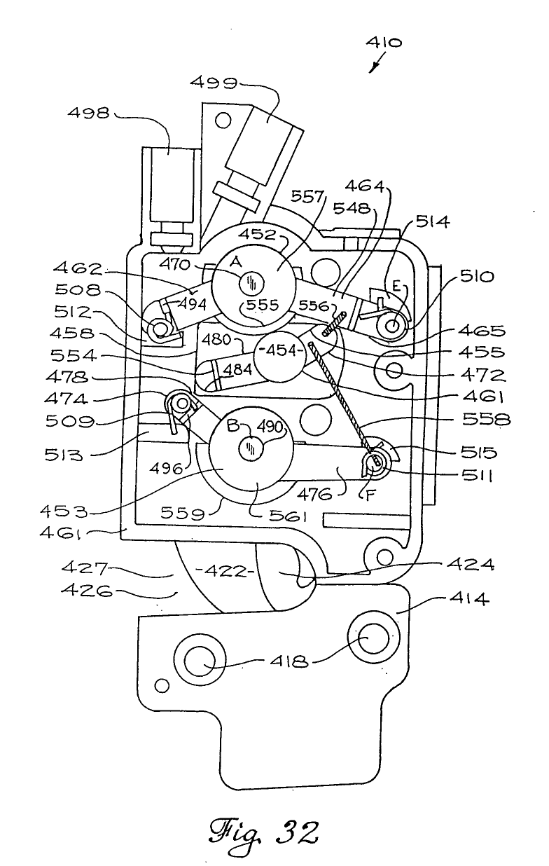

By way of example only, one such alternative arrangement is illustrated in FIGS. 32-34. The latch assembly shown in FIGS. 32-34 is substantially the same as that shown in FIGS. 17-31, but with the exceptions described hereinafter. Reference numerals in this third embodiment are increased with respect to those in the second preferred embodiment to the 400 and 500 number series.

As can be seen in FIG. 32, the upper control element 452 and the lower control element 453 are each connected to the pawl 454 by a respective link 556, 558. The links 556, 558 can take virtually any shape and can be connected to the control elements 452, 453 and to the pawl 454 in any conventional manner which allows relative movement of the control elements 452, 453 and the pawl 454 (i.e., by welding, brazing, gluing, fastening with fasteners, and the like). Preferably however, the links 556, 558 are U-shaped wires or rods bent to fit within suitably sized apertures in the control elements 452, 453 and the pawl 454. As such, the links 556, 558 are easy to install in a layered fashion with the other elements as will be discussed in more detail below.

In the latch assembly 410 illustrated in FIG. 32, actuation of the upper and lower control elements 452, 453 when they are engaged with the engagement elements 466, 486 does cause the pawl 454 to move sufficiently to release the ratchet 422, but not via camming contact of the control elements 452, 453 against the pawl 454. Instead, when the upper control element 452 is rotated clockwise about point A (when the upper engagement element 466 is extended within aperture 470), the lever end 464 of the upper control element 452 moves downward as in the second preferred embodiment discussed above. The upper link 556 thereby transfers motive force to the lever end 472 of the pawl 454 to rotate the pawl 454 and to release the ratchet 422. However, when the upper control element 452 is actuated without being engaged by the upper engagement element 466, the upper control element 452 rotates about point E (see FIG. 32), thereby generating insufficient movement to push the lever end 472 of the pawl 454 downward to release the ratchet 422. The difference in movement between the upper control element 452 in an engaged and a disengaged state is similar to the difference shown in FIGS. 26 and 28 of the second preferred embodiment. In FIG. 26, the lever end 264 of the upper control element 252 moves a significant amount because point A represents the fulcrum of the upper control element 252. In FIG. 28, the lever end 264 of the upper control element 252 moves relatively little because point C is the fulcrum of the upper control element 252. By connecting a link 556 at the lever end 464 of the upper control element 452 in the third preferred embodiment shown in FIG. 32, similar motion characteristics are used to either transfer or not transfer motive force to the pawl 454. To help guide the upper control element 452 in its actuation movement when not engaged by upper engagement element 466, a wall 555 is preferably located beside a portion of the central section 557 of the upper control element 452. The wall 555 is preferably integral with the housing 416, but can instead be attached thereto or extend from the cover plate 482 or other portion of the latch assembly 410 as desired. As shown in FIGS. 32-34, the wall 555 is preferably U-shaped to guide the upper control element 452 in its upward movement when actuated in its latched state. When actuated in its unlatched state, the upper control element 452 preferably remains in place in the U-shaped wall 555. One having ordinary skill in the art will recognize that other wall shapes can be employed to guide control elements moving in different manners in their unlatched states as necessary.

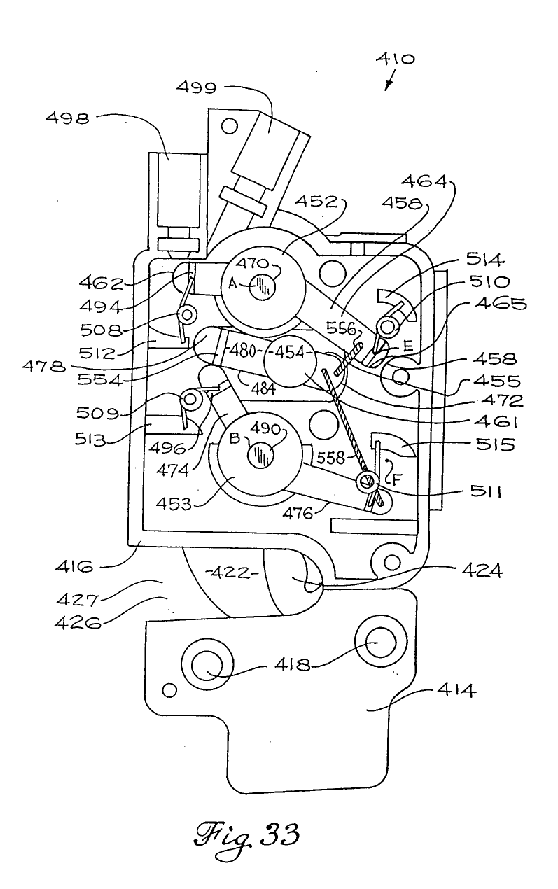

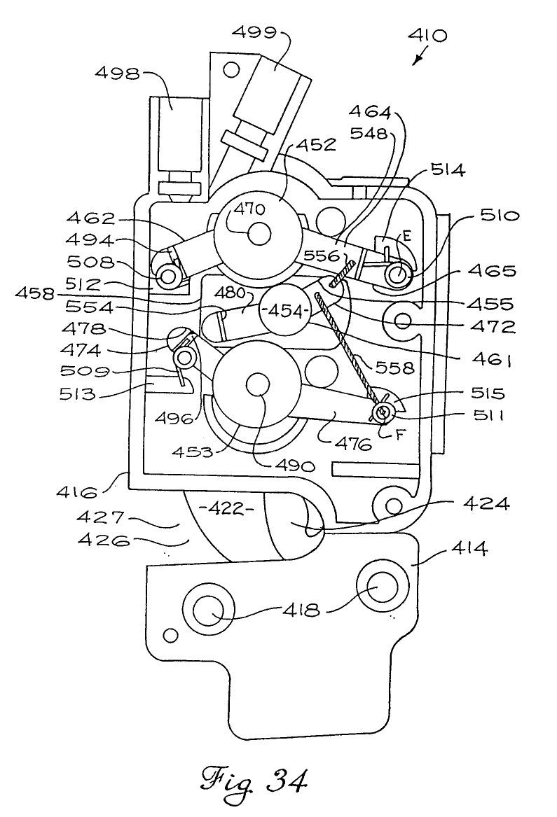

Similarly, and with reference to FIG. 33, when the lower control element 453 is rotated clockwise about point B (when the lower engagement element 486 is extended within aperture 490), the lever end 476 of the lower control element 453 moves downward as in the second preferred embodiment discussed above. The lower link 558 thereby transfers motive force to the lever end 472 of the pawl 454 to rotate the pawl 454 and to release the ratchet 422. However, when the lower control element 453 is actuated without being engaged by the lower engagement element 486, the lower control element 453 rotates about point F as shown in FIG. 34, thereby generating insufficient movement to pull the lever end 472 of the pawl downward to release the ratchet 422. The difference in movement between the lower control element 453 in an engaged and a disengaged state can be seen by comparing FIGS. 33 and 34. In FIG. 33, the lever end 476 of the lower control element 453 moves a significant amount because point B represents the fulcrum of the lower control element 453. In FIG. 34, the lever end 476 of the lower control element 453 moves relatively little because point F at the lower end of the link 558 is the fulcrum of the lower control element 453. By connecting a link 558 at the lever end 476 of the lower control element 453, these motion characteristics are used to either transfer or not transfer motive force to the pawl 454. Preferably, and as with the upper control element 452 described above, a wall 559 is located beside a portion of the central section 561 of the lower control element 453 to help guide the lower control element 453 in its actuation movement when not engaged by the lower engagement element 486. The wall 559 is preferably integral with the housing 416, but can instead be attached thereto or extend from the cover plate 482 or other portion of the latch assembly 410 as desired. Like the wall 555 for the upper control element 452, the wall 559 is preferably U-shaped to guide the lower control element 453 in its upward movement when actuated in its latched state (see FIG. 34). When actuated in its unlatched state, the lower control element 453 preferably remains in place in the U-shaped wall 559.

It will be appreciated by one having ordinary skill in the art that the links 556, 558 can each be connected to at least one of a number of different locations along the lengths of the control elements 452, 453 to create motion characteristics similar to those just described. Also, the links 556, 558 can have different lengths than those shown in the figures to accommodate different spacings existing between the pawl 454 and the control element 452, 453 and to permit linking along different locations of the control elements 452, 453 and the pawl 454 as desired. These different connection arrangements and link lengths fall within the spirit and scope of the present invention.

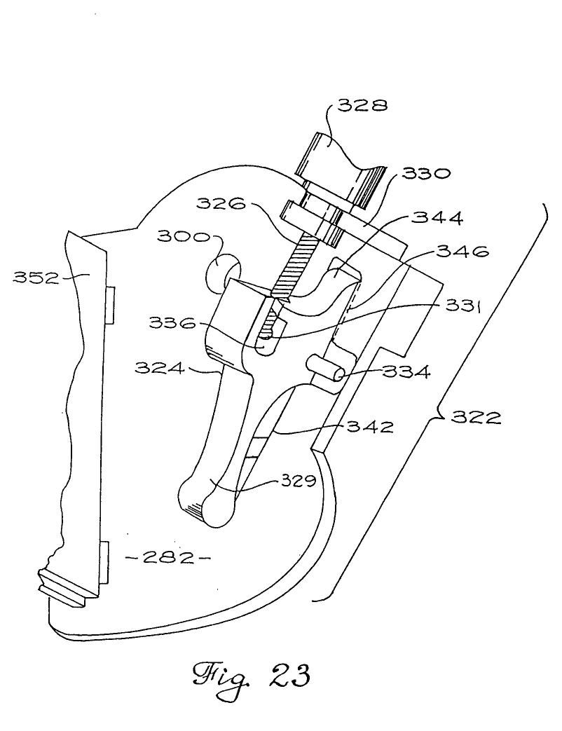

With reference back to the latch assembly of the second preferred embodiment of the present invention, the latch assembly 210 operates upon some of the same basic principles of the present invention as described in the first preferred embodiment (i.e., quick change between locked and unlocked states of the control elements 252, 253 by efficient and fast actuator motion to drive engagement elements 266, 286 into and out of engagement with the control elements 252, 253). As is best seen in FIG. 23, the second preferred embodiment of the present invention also preferably has a manual override device 322 which permits a user to manually move at least one of the pins 266, 286 (or other engagement element type used) between its locked and unlocked states. The ability to perform this function is useful, for example, where it is desirable to link a user-operable device such as a lock cylinder to the latch assembly 210, allowing a user to unlock the latch assembly 210 even during power interrupt.

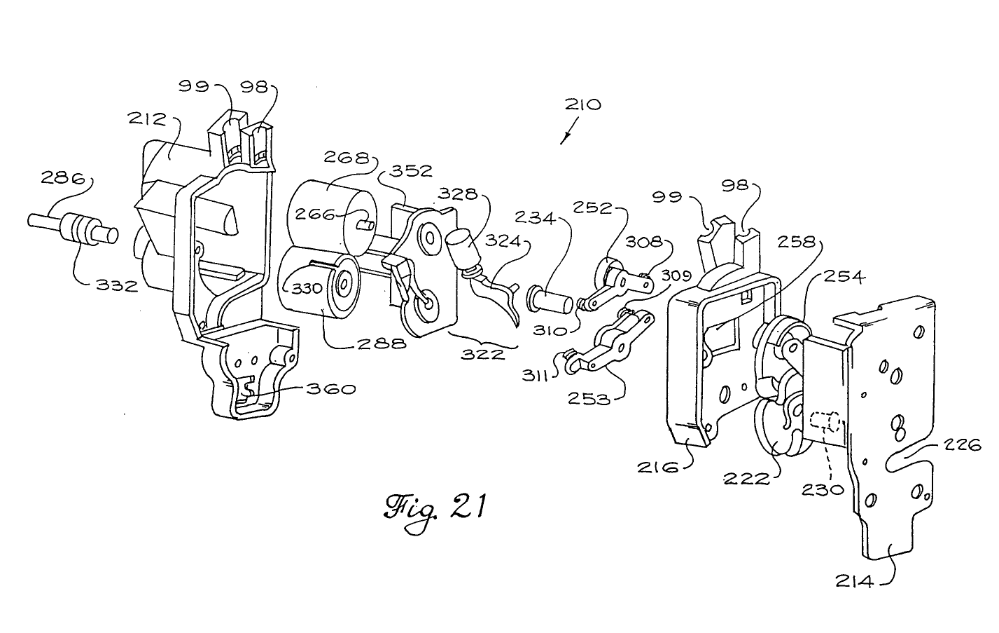

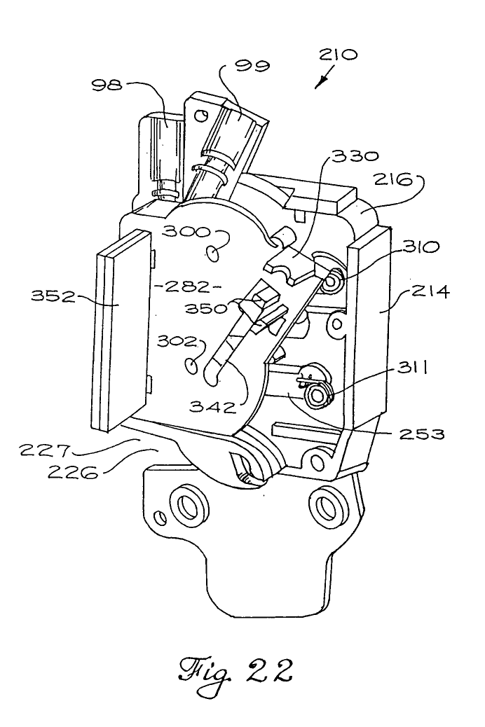

With reference to FIGS. 22 and 23, a preferred embodiment of a manual override device 322 will now be described. The manual override device 322 preferably has a bell crank 324 connected to an end 331 of a cable 326 via a cable end clip 328. The bell crank 324 preferably operates as described below to manually move the armature of the lower actuator 288 into engagement with the lower control element 253 (corresponding to an outside car door handle in a preferred application). To do so, the bell crank 324 preferably has a tail 329 extending therefrom which is preferably directly or indirectly connected in a conventional manner to the armature of the lower actuator 288. In the preferred embodiment of the present invention illustrated in the figures, the tail 329 preferably extends through an elongated aperture 330 (see FIGS. 20 and 21) in the side of the lower actuator 288 and into a receiving groove 332 of the armature therein. The bell crank 324 also preferably has a pivot 334 about which the bell crank 324 is pivotable by actuation of the cable 326. Also, the bell crank 324 preferably has an aperture 336 into which the end of the cable 326 is fitted. Preferably, the aperture 336 has a dogleg extension (see FIG. 23) permitting the end 331 of the cable 326 to be fitted into the aperture 336 but preventing the end 331 of the cable 326 from being pulled out of the aperture 336 when the cable 326 is pulled. The end 331 of the cable 326 also preferably is enlarged (most preferably in a ball shape as shown in FIG. 23) to prevent the cable 326 from being pulled out when the cable 326 is pulled. With additional reference to FIG. 20, the cable clip 328 properly positions the cable 326 with respect to the housing 216 and preferably has a conventional groove therein for seating within a cable seat 338. The cable clip 328 preferably fits within an aperture 340 in the housing 216 and/or front cover 212 as shown in the figures. To assist the bell crank 324 in its movement as described below, one or more blocks, walls, posts, pins, or other elements 350 can be located around or beside the bell crank 324 as shown in FIG. 22 (removed from FIG. 23 for clarity). These elements 350 can be integral with or attached to the cover plate 282 as shown in FIG. 22, or can extend from the housing 216 or front cover 212 as desired.

When the above-described manual override device 322 is actuated (i.e., when the cable 326 is pushed), the cable end trapped in the bell crank aperture 336 pushes the bell crank 324 about its pivot 334, thereby pushing the tail 329 and the connected armature of the lower actuator 288 toward the lower control element 253 to engage the lower pin 286 with the lower control element 253. As described above, this action places the lower control element 253 into an unlocked state. Preferably, when the cable 326 is pulled rather than pushed, the bell crank 324 pivots in an opposite direction to pull the lower pin 286 out of engagement with the lower control element 253 and to thereby place the lower control element 253 in a locked state. In alternative embodiments to the preferred embodiment shown in the figures, the connection between the bell crank 324 and the cable 326 (or rod, lever, chain, or other linking device connected to the bell crank 324 for actuation thereof) permits only one-directional actuation. In other words, the connection permits the cable 326 or other such linking device only to pull the bell crank or only to push the bell crank. These alternative embodiments can employ lost motion connections for this purpose or linking devices that are capable of transmitting pulling force but not pushing force.

If desired, the cover plate 282 can be shaped to receive the bell crank 324 in a recessed manner. Specifically, the cover plate 282 can have a recess 342 as best shown in FIG. 22, in which is pivotably received the bell crank pivot 334 and the bell crank tail 329.

One having ordinary skill in the art will appreciate that the particular manual override device 322 illustrated in the figures is only one of a large number of well-known manual overrides which can be used to manually manipulate the position of an actuator armature or pin 266, 286 in the latch assembly 210. For example, a similar bell crank assembly can be used as described above, but with the tail 329 of the bell crank 324 coupled to a pin 286 for moving the pin 286 into and out of engagement with the lower control element 253 rather than moving the armature connected (directly or indirectly) thereto. Also, a bell crank assembly can be adapted in a well-known manner to push the armature or pin 286 into engagement with the lower control element 253 when the cable 326 is pulled and to pull the armature or pin 286 out of engagement with the lower control element 253 when the cable 326 is pushed. Such a change can be made, for example, simply by changing the location of the tail 329 on the bell crank 324 and repositioning the bell crank 324 in the latch assembly 210. As another example, the bell crank 324 need not necessarily be in camming contact with a control element to be pivoted about its pivot 334. Instead, motive force can be exerted upon the bell crank 324 by movement of a control element in any conventional manner, including those described above with reference to the third preferred embodiment of the present invention (e.g., by a link connecting the bell crank 324 to a control element, via repulsive magnetic force of magnets on the bell crank 324 and on a control element, by a control element exerting force upon a third element which in turn exerts force upon the bell crank 324, and the like).

A manual override device for the lower control element 253 is preferred as shown in the figures, because in the preferred embodiment of the present invention a user can manually unlock the outside door handle as needed. However, it will be appreciated by one having ordinary skill in the art that a manual override device such as that described above and illustrated in the figures can be used for the upper control element 252 or for both the upper and lower control elements 252, 253. Either or both of the inside and outside door handles can therefore be manually unlocked by a user. Where a manual override device exists for both control elements 252, 253, such a device can be shaped to actuate the armatures or pins 266, 286 simultaneously (e.g., two cables connected to the same bell crank 324 having a tail running to each armature or pin 266, 286). Otherwise, a separate bell crank 324, cable 326, and cable end clip 328 assembly can be used to selectively actuate either armature or pin 266, 286 independently of the other. It should also be noted that although the lower control element 253 is connected to the outside door handle and the upper control element 252 is connected to the inside door handle in the preferred application of the present invention, these associations can be reversed as discussed below. Also, the particular locations of the control elements 252, 253 (i.e., upper, lower, left, right, etc.) are largely irrelevant to the number and operation of manual overrides used. None, one, two, more, or all of the control elements in any particular latch design according to the present invention can have a manual override associated therewith as desired, regardless of which user-operable handle or other such device is used to actuate the control elements (i.e., inside door handle, outside door handle, and the like).

Although a bell crank 324 is preferably used to accomplish the manual override function of moving the armatures or pins 266, 286 with respect to the control elements 252, 253, other well-known devices and assemblies can instead be used to accomplish this function. By way of example only, one alternative assembly is a lever having a forked end engaged with an actuator 268, 288, pin 266, 286, or pin plate and an opposite end movable by a separate actuator, cylinder, magnet, or other conventional device to actuate the lever between at least two positions. In another alternative assembly, a lever or bell crank can be attached directly to a control element 252, 253 which itself is permitted limited axial movement (limited by the axial movement of the torsion springs 308, 309, 310, 311) toward or away from the associated actuator 268, 288 for engagement therewith. In yet another alternative assembly, a lever or bell crank can have its own pin insertable by actuation directly into the control element aperture 270, 290. In such a design, the shapes of the bell crank pin and the actuator pin would preferably be complementary (i.e., two semi-circular extruded shapes facing one another and together having a round pin shape) to allow movement of one independently of the other into and out of the control element apertures 270, 290. Still other manual overrides are possible and fall within the spirit and scope of the present invention.

With reference again to FIG. 23, it can be seen that the bell crank 324 preferably has an extension 344 extending from the pivot 334. The extension 344 has a cam surface 346 which is located on the side of the cover plate 282 opposite the cable 326 and bell crank aperture 336. The cam surface 346 is preferably located in the latch assembly 210 adjacent to the lever end 264 of the upper control element 252. As best seen in FIG. 24, the lever end 264 of the upper control element 252 preferably has a ramped cam portion 348 (hereinafter referred to only as the ramped portion 348). When the upper control element 252 is engaged by the upper pin 266 (i.e., in the unlocked state as described above), the lever end 264 moves in a downward direction when the upper control element 252 is actuated. As also described above, this action turns the pawl 254 to release the ratchet 222. In the preferred embodiment of the present invention illustrated in the figures, this motion also causes the cam surface 346 of the bell crank 324 to ride up upon the ramped portion 348 of the upper control element 252. This motion pivots the bell crank 324 about its pivot 334 and pushes the pin 286 into the aperture 290 of the lower control element 253, thereby placing the lower control element 252 in its unlocked state in a manner as described above. This feature is useful in applications where actuation of one control element in its unlocked state causes another control element to switch states. For example, in car doors applications where a user opens the door from the inside, it is often desirable to automatically unlock the door for access from the outside (i.e., unlock the outside door handle).

The above-described arrangement can be applied in substantially the same manner so that actuation of the lower control element 253 in its unlocked state causes pivoting of the bell crank 324 to unlock the upper control element 252. Such an arrangement can even be used so that actuation of either control element 252, 253 in its unlocked state causes the other control element 253, 252 to be shifted to its unlocked state. It should also be noted that the ramped portion of the control elements in each of the above cases can be reversed to cause locking of one control element when the other is actuated in its unlocked state. In still other embodiments employing the same ramped portion and bell crank cam surface design, it is even possible to generate the camming motion when a control element is actuated in its locked state, or regardless of the state of the control element. Because the control elements 252, 253 move in different manners in their locked and unlocked states, the desired camming motion can be achieved in each case by positioning the bell crank 324 so that the ramped portion of the control element moves to cam against the cam surface 346 of the bell crank 324 only in the selected motion of the control element (i.e., in its locked state or its unlocked state).

In yet another alternative embodiment of the ramped portion and bell crank cam surface design just described, it is possible to located the ramped portion 348 upon the pawl rather than upon a control element. Therefore, the bell crank 324 or other such device as described above would preferably shift the state of a control element only when the pawl 254 is rotated between its latched and unlatched positions. The ramped surface 348 can be located on any portion of the pawl 254 or upper pivot post 234 facing the bell crank 324, which itself would be positioned adjacent the ramped surface 348 in the same manner as described above.

In the second preferred embodiment of the present invention described above and illustrated in FIGS. 17-31, the manual override device 322 is capable of performing at least two functions: manual override in response to actuation of a cable 326, linkage, rod, or other such element of the manual override device 322, and manual override in response to movement of a control element. Both of these functions need not necessarily be performed by a manual override device 322. Specifically, a manual override device can have just a connection point for an external cable 326, linkage, rod, and the like (without a cam surface 346) or can have a cam surface 346 without such a connection point. Different manual override devices 322 in the same latch assembly can take either form as desired for the functionality of the latch assembly.

The preferred embodiments of the present invention demonstrate the application flexibility of the present invention. In particular, the latch assemblies described above and illustrated in the figures can be quickly adapted for use in a number of different applications. For a more universal latch assembly, multiple ports 98, 99 can be located in different locations around the sides of the housing 216 and/or front cover 212. An installer can therefore run any desired linking element (preferably bowden cables) from outside the latch assembly 10, 210 to the control elements 52, 53, 252, 253 inside from a number of different angles with respect to the latch assembly 10, 210. Such a latch assembly can be immediately installed into a large number of applications in which linking elements are run from different locations with limited space for re-routing such linking elements.

Similarly, either or both control elements 52, 53, 252, 253 can be modified to extend past the housing 16, 216 or front cover 12, 212 out of a suitably sized aperture. For example, although both control elements 252, 253 in the second preferred embodiment described above and illustrated in the drawings are located inside the housing 216 and are connected internally to cables running inside the housing 216, the ends 262, 274, 264, 276 of either or both of these control elements 252, 253 can be lengthened to extend outside of the housing 216 via housing apertures in the side of the housing 216 (much in the same way as the right control element 52 extends outside of the housing 16 in the first preferred embodiment) for connecting linking elements thereto. For this purpose, alternative embodiments of the present invention can have housing apertures in a number of locations around the housing 16, 216 to permit a user to use exteriorly-connected control elements when desired.

It may also be desirable to connect the cables in the second preferred embodiment of the present invention to the opposite ends of the control elements, either inside or outside of the housing 216. Alternative embodiments of the present invention provide for ports and housing slots on both sides of the housing so that control elements can be selected for linkage on either side of the housing—externally or internally. It is even possible to employ control elements which can be installed in one fashion (e.g., face up in the housing 16, 216) to extend the ends 262, 274, 264, 276 out of one side of the latch assembly 10, 210 or adjacent ports on one side of the latch assembly 10, 210, and in another fashion (e.g., face down in the housing 16, 216) to extend the ends 262, 274, 264, 276 out of an opposite side of the latch assembly 10, 210 or adjacent ports on the opposite side of the latch assembly 10, 210 for connecting linking elements thereto. In short, the present invention can be applied to create a universal latch assembly having multiple ports and multiple housing holes so that different control elements having different lengths can be installed in a number of different orientations for connection either inside or outside the latch assembly. This flexibility also permits connection to a wide variety of linking elements, such as cables, rods, chain, and the like connecting the control elements with user-operable devices to actuate the control elements. Although in some embodiments multiple control elements types (i.e., having different shapes and lengths) would be needed to enable latch installation in a wide range of applications, other elements of the latch assembly require no modification. As such, only different control elements are needed rather than different latch assemblies.

Another important advantage of the present invention is the modularity of the latch assemblies disclosed. A latch assembly according to the present invention can be manufactured to house a number of control elements in a number of different control element positions, as well as the actuators, pins, and other elements associated with each control element. The control element positions can be, for example, right and left positions for right and left control elements as in the first preferred embodiment described above, upper and lower positions for upper and lower control elements as also described above, etc. Therefore, an assembler can include any desired number of control elements placed in any of the locations in the latch assembly to define a number of different latch assembly configurations. The linking elements (i.e., the cables, rods, and the like) can be connected to the control elements in the positions for actuation thereof as needed. For example, in the second preferred embodiment of the present invention described above, both cables running through ports 98, 99 can be connected to the upper control element 252 for actuation thereof. Actuation of the upper pin 266 by the actuator 268 would therefore lock and unlock the inside and outside door handles in the preferred car door application. In this example, the lower control element 253 and associated hardware would not be needed and would not be installed. If, however, full functionality of the door were desired in another application, the assembler would install and connect the lower control element 252.

The latch assembly 10, 210 of the present invention therefore has multiple operational modes which are determined at least in part by the number of control elements 52, 53, 252, 253 installed in positions in the latch assembly 10, 210 and the manner in which the control elements 52, 53, 252, 253 are connected for actuation to external inputs (such as handles) by linking or “input” elements (such as bowden cables or connecting rods). The latch assembly can be quickly and easily built for a number of different applications by installing and connecting only the elements required for the latch functionality desired. The same general latch structure can preferably be used regardless of the degree of functionality in any particular application (e.g., one mode in which two handles are locked or unlocked together via connection to one control element, another mode in which the two handles can be locked independently of one another by being connected to respective control elements, yet another mode in which two handles connected to the same control element are locked and unlocked together while a third handle connected to another control element is locked or unlocked independently, etc.). The number of control element positions, ports, and housing holes are preferably selected to facilitate latch installation in an optimal number of different applications.

To further increase the installation flexibility of the present invention, highly preferred embodiments permit connection of linking elements such as bowden cables, rods, and the like directly to the pawl. With reference to FIGS. 24-29 of the second preferred embodiment, the pawl 254 can have a pawl groove, slot, hole, or other aperture for connection of a linking element thereto in much the same manner as the linkage ends 262, 274 of the control elements 252, 253 are connectable to linking elements. Like the control elements 252, 253, other connection manners for connecting the pawl 254 to a linking element are well-known to those skilled in the art and are therefore not described further herein. Most preferably, the linking elements connected to the control elements 252, 253 are interchangeably connectable to the pawl 254. By enabling linking element connection directly to the pawl 254 and by permitting fully interchangeable connection between the pawl 254 the upper control elements 252, and the lower control element 253, the user can install the latch assembly 210 in any number of different ways. For example, the user can connect both bowden cables from the ports 98, 99 to respective upper and lower control elements 252, 253 as described above, both bowden cables in a reversed manner to the lower and upper control elements 253, 252, both bowden cables to the upper control element 252 alone, both to the lower control element 253 alone, one to the upper control element 252 and one to the pawl 254, one to the lower control element 253 and one to the pawl 254, both directly to the pawl 254, etc. Each such connection results in a differently functioning latch assembly, any one of which may be desired in a particular application. Where more than two control elements exist in a latch assembly, still further connection possibilities and latch functionality results. The universal nature of connection to the control elements and the pawl of the present invention creates a latch assembly which is highly flexible and adaptable to a large number of applications without significant latch assembly change.

The latch assemblies of the present invention also provide an important advantage over conventional latch assemblies insofar as assembly speed and ease is concerned. Unlike conventional latch assemblies which require a user to flip and rotate the latch assembly in a number of different orientations during the assembly process, the latch assemblies of the present invention are designed to avoid the need for latch movement during assembly. The latch assembly 10, 210 of the present invention has a layered assembly structure in which elements are placed and installed in the latch assembly 10, 210 in layers. In other words, elements of the latch assembly 10, 210 are substantially located in the latch assembly in a number of planes passing through the latch assembly 10, 210. With reference to the figures, each latch assembly disclosed has a layer in which the pawl 54, 254, ratchet 22, 222, lower pivot post 30, 230, and upper pivot post 34, 234 are installed and located on rear mounting plate 14, 214. After the installation of the pawl 54, 254 and ratchet 22, 222, the remaining assembly of the latch assembly can be performed from one side of the latch assembly 10, 210 (thereby avoiding the need to repeatedly turn over the latch assembly when installing elements). The assembler can install the control elements 52, 53, 252, 253 by placing them in their desired locations (via the torsion springs 308, 309, 310, 311 in the case of the second preferred embodiment), and connecting them by a control element spring 92 if needed. In this same second layer of elements, the assembler can connect the linking elements to the control elements 52, 53, 252, 253 and/or to the pawl 54, 254 which straddles the first and second layers of elements. In a third layer of elements, the assembler can install the control plate 82, 282, pin plates 104, 106, pins 66, 86, 266, 286 (which are extendable into the second layer of elements), actuators 68, 88, 268, 288, and front cover 12, 212. The ability of an assembler to position and install the large number of elements in the second and third layers mentioned above without access from behind the housing 216 results in a much faster assembly time and a much more easily assembled latch. The overall cost of the latch assembly 10, 210 and of latch maintenance and repair is therefore lowered significantly. Of course, changes to the exact locations of one or more elements in the latch assembly are possible without departing from the advantages of the layered assembly in the present invention.

Another preferred feature of the present invention relates to smooth operation of the latch assembly. Specifically, a number of embodiments described above enable more than one cable, rod, or other such linking device to be coupled to the same element for independent actuation thereof. For example, cables run through both ports 98, 99 in the second preferred embodiment can be attached to the same control element 252, 253 or even to the pawl 254. To prevent reaction of one cable (or rod or other such device employed) from reacting to the actuation of the other cable in such cases, the grooves 294, 296, 354 are preferably sufficiently wide to permit the non-actuated cable to remain substantially stationary. In other words, the connected element preferably provides for an amount of lost motion between the cables, rods, or other such devices connected thereto. With reference to the second preferred embodiment of the present invention described above, it should also be noted that the cable 326 (or rod or other such device employed) connected to the bell crank 324 is preferably received in an aperture 336 that is elongated to provide an amount of lost motion for the cable 326. Therefore, when the bell crank 324 is moved by camming action between a ramped portion of a control element 252, 253 or pawl 254 and the bell crank 324 as described above, the bell crank 324 does not actuate the cable 326 or any user-operable device such as a handle connected thereto.

The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention as set forth in the appended claims. For example, although the present invention can be employed with excellent results in vehicle doors, the present invention can be used in any application where one body is releasably latched to another body via a movable element (e.g., a ratchet) having a latched state and an unlatched state controlled by interference caused directly or indirectly by one or more control elements 52, 53, 252, 253. Such applications can be in non-vehicle environments and can be virtually any size (e.g., from large canal door latches to miniature device latches). The moveable element need not necessarily be a ratchet or even rotate about a pivot point, but at least is selectively held in latched and unlatched states by either a pawl or like device or directly by a control element 52, 53, 252, 253.

In light of the above, it should be noted that the particular device used to capture the striker 20, 220 or other element captured by the latch assembly 10, 210 can be significantly different than that described above and illustrated in the drawings. Though important to operation of the latch assembly 10, 210 other elements and mechanisms beside a pivotable ratchet and spring arrangement can be used to interact either with the pawl 54, 254 or directly with the control element(s) 52, 53, 252, 253 if a pawl 54, 254 is not used. One skilled in the art will recognize that it is possible to eliminate the pawl 54, 254 in alternative embodiments of the present invention and to design the control element(s) to ride upon and limit the rotation of the ratchet 22, 222 in much the same way as the pawl 54, 254. In such alternative embodiments, the inventive principles herein are still employed: moving a control element in one manner when engaged by an engagement element (e.g., a pin controlled by a solenoid) and in another manner when disengaged. In one manner, the control element moves to directly or indirectly release the ratchet 22, 222 and in another manner, movement of the control element does not directly or indirectly release the ratchet 22, 222. Where a pawl 54, 254 is employed, sole rotational movement of the pawl 54, 254 is not a requirement. For example, the pawl 54, 254 can be shifted or translated against spring force in one direction when the control elements act upon the pawl 54, 254 in their unlocked states and be unaffected when the control elements are in their locked states. Even a combined translation and rotation of the pawl 54, 254 is possible when actuated by the control elements. Also, it should be noted that multiple pawls can be used, if desired, to interact with different stop surfaces of the ratchet 22, 222 in more complex latch assemblies.

In addition to the variations and alternatives just discussed, the control elements 52, 53, 252, 253 can also be significantly different than described above and illustrated in the figures. For example, the right and left control elements 52, 53 of the first preferred embodiment are disclosed herein as being generally straight and generally L-shaped, respectively. However, it is possible that both elements can be made identical (and placed on top of one another with their linkage ends 62, 74 adjacent to one another, placed in a similar orientation to that shown in the figures, etc.). Also, the control elements 52, 53, 252, 253 can be virtually any shape, as long as the control elements 52, 53, 252, 253 move in a first manner to directly or indirectly release the ratchet 22, 222 as described above and to not do so when moving in a second manner, the manners of movement being controlled by engagement with the pins 66, 86, 266, 286.

As described above and illustrated in the figures, the control elements 52, 252 and 53, 253 are preferably selectively engaged for rotation about pivot points A and B, respectively, by pins 66, 266, and 86, 286. The pins 66, 86, 266, 286 are controlled by the actuators 68, 88, 268, 288 to be inserted into and retracted from the apertures 70, 90, 270, 290 in the control elements 52, 53, 252, 253. This relationship is only one of a number of different engagement relationships possible in the present invention. Specifically, the pins 66, 86, 266, 286 are only one type of engagement element performing the function of controlling the movement of the control elements 52, 53, 252, 253 in a particular manner when engaged (e.g., by allowing only rotation of the control elements 52, 53, 252, 253 about pivot points A and B). The present invention resides not in the particular type or shape of engagement element, but in the control of the control elements 52, 53, 252, 253 when the pins 66, 86, 266, 286 are in their engaged states. Therefore, one having ordinary skill in the art will recognize that the location of the pins 66, 86, 266, 286 and the apertures 70, 90, 270, 290 can be reversed, with pins in the control elements 52, 53, 252, 253 fitting into apertures in the plates 104, 106 or actuators 68, 88, 268, 288.

Engagement of the control elements 52, 53, 252, 253 by the actuators 68, 88, 268, 288 can also be performed for example, by bumps in the control elements 52, 53, 252, 253 fitting into dimples in the pin plates 104, 106 or actuators 68, 88, 268, 288 (or vice versa), by one or more teeth in the control elements 52, 53, 252, 253 and in the pin plates 104, 106 or actuators 68, 88, 268, 288 meshing together when engaged, by a magnetic or electromagnetic connection established between the pin plates 104, 106 or actuators 68, 88, 268, 288 and the control elements 52, 53, 252, 253 etc. All such alternatives to the pin and aperture arrangement in the preferred embodiment of the present invention share the inventive principle of using an actuator to engage the control elements 52, 53, 252, 253 for controlling their movement as described above. It should be noted that the particular location of the pins, teeth, bumps, or other engagement elements need not necessarily be between the actuators 68, 88, 268, 288 and the control elements 52, 53, 252, 253. Instead, the engagement elements can be located between the control elements 52, 53, 252, 253 and the housing 16, 216, if desired. For example, the pins, teeth, bumps, or magnets can be located on the housing 16, 216 normally disengaged from the control elements 52, 53, 252, 253 when the actuators 68, 88, 268, 288 are in their retracted positions. When the actuators 68, 88, 268, 288 are extended, they can push the control elements 52, 53, 252, 253 into engagement with the pins, teeth, bumps, or magnets on the housing 16, 216 to thereby engage the control elements 52, 53, 252, 253 for a particular motion (as the pins 66, 86, 266, 286 in the preferred embodiments described above do).

The latch assembly 10, 210 of the present invention as disclosed herein employs an engagement element or elements such as pins 66, 86, 266, 286, teeth, bumps, or magnets engaging with an element or elements such as apertures 70, 90, 270, 290, teeth, dimples or magnets in the control elements 52, 53, 252, 253 (or vice versa). However, one having ordinary skill in the art will recognize that the engagement elements need not interact by inserting one engagement element into another (such as a pin 66, 86, 266, 286 into an aperture 70, 90, 270, 290 in the control elements 52, 53, 252, 253). Instead, the engagement elements can simply be actuated to provide guidance surfaces to control the movement of the control elements 52, 53, 252, 253 when actuated. For example, in the case of the pin and aperture arrangement of the preferred embodiment, the pins 66, 86, 266, 286 need not be inserted into apertures in the control elements 52, 53, 252, 253. Instead, the pins 66, 86, 266, 286 can be inserted alongside the control elements 52, 53, 252, 253 so that when the control elements 52, 53, 252, 253 are actuated by a user, the pins 66, 86, 266, 286 guide the control elements 52, 53, 252, 253 along a particular path that is different than that taken by the control elements 52, 53, 252, 253 when the pins 66, 86, 266, 286 are retracted. The control elements 52, 53, 252, 253 need not therefore be limited for solely rotational movement (such as in the preferred embodiments of the present invention) in either state. In fact, movement of the control elements 52, 53, 252, 253 in the extended and retracted states of the pins 66, 86, 266, 286 can be purely translational or be a combination of rotation and translation. A broad aspect of the present invention resides not necessarily in the specific rotation, translation, or combined rotation and translation of the control elements 52, 53, 252, 253 in either their locked or unlocked states, but rather in a path of control element motion imparting movement to the pawl 54, 254 (if used) in one actuator state and a path of control element motion not imparting such movement in a second actuator state. Because the two paths of motion are determined by the placement of the pins 66, 86, 266, 286 and the shape of the control elements 52, 53, 252, 253, the path imparting motion and the path not imparting motion need not correspond to the extended and retracted positions of the pins 66, 86, 266, 286. The path imparting motion and the path not imparting motion can correspond instead to the retracted and extended positions of the pins 66, 86, 266, 286 as desired.

In addition to the manual override device embodiments described above with regard to the second preferred embodiment of the present invention, still other manual override devices can be used. The manual override device can be coupled to at least one of the control element 52, 53, 252, 253 the pawl 54, 254 and the actuator 68, 88, 268, 288. As described above, the manual override operates to change the states or modes of the latch assembly 10, 210 in a supplemental manner to the manners previously described. The manual override can include a wide variety of manually actuated mechanical or electronic devices, but preferably includes a lock or a lock plunger. It will be apparent to one of ordinary skill in the art that the coupling of the manual override to the latch assembly 10, 210 will vary depending upon the particular manual override selected. For example, where the manual override comprises a cylinder lock, any of the previously described linking elements can be used satisfactorily to couple the manual override to the latch assembly 10, 210. In one highly preferred embodiment, the cylinder lock includes a projection for driving a mechanical linkage that is connected directly to the engagement elements of the latch assembly 10, 210, such as to the linkage end 62, 262 of the right control element 52 or upper control element 252. Alternatively, an electronic manual override such as an electronic lock can be electronically coupled to an electronic actuator, or can be used to actuate a mechanical element or linkage.

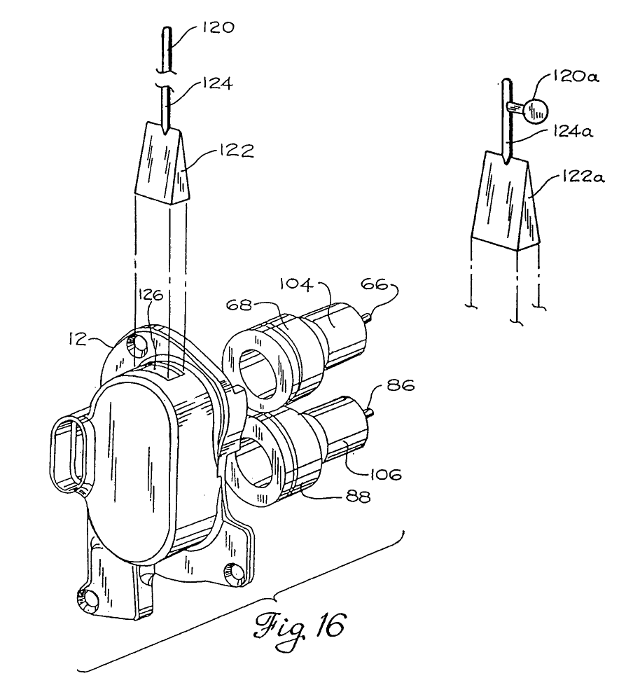

Two manual override assemblies are illustrated by way of example in FIG. 16, and are shown installed on a latch assembly according to the first preferred embodiment of the present invention. However, it should be noted that the same manual override assemblies can be installed and employed on any of the latch assembly embodiments described above and illustrated in the figures. On the left in FIG. 16 is a conventional user-activated lock pin 120 accessible from within the vehicle and used to manually override the latch assembly 10. The lock pin 120 can be connected to a wedge shaped element 122 inserted within the latch assembly 10 as shown by the dashed lines. Specifically, a rod 124 or other conventional linking member can extend from the lock pin 120, into an aperture 126 in the cover 12, and to the wedge shaped element 122. As such, lifting the lock pin 120 will move the wedge shaped element 122 in an upward direction as viewed in FIG. 16, thereby causing the wedge shaped element 122 to act upon the pin 66 to push it into its unlocked state (note that the rear end of the pin 66 preferably extends through and past the actuator 68 when in its fully retracted position). Depressing the lock pin 120 will permit the pin 66 to retract, when actuated, to place the pin 66 in its locked state again.

Another type of manual override is also shown by way of example in FIG. 16. Where, as preferred, the manual override is operated by a cylinder lock 120a, the cylinder lock 120a can be connected to a wedge shaped element 122a inserted in the latch assembly 10. Like the manual override 120, 122, 124 described above, a rod 124a or other conventional linking member can extend from the cylinder lock 120a into the aperture 126 in the cover 12, and to the wedge shaped element 122a. When the cylinder lock 120a is turned by an authorized user, the rod 124a and the wedge shaped element 122a act in a similar manner as described above to place the pin 66 in its locked and unlocked states. The manual overrides illustrated in FIG. 16 are shown only by way of example. One skilled in the art will recognize that many other manual override devices and systems can instead be used to achieve the same result. Also, a manual override can be coupled to both pins 66, 86, 266, 286 or just to the lower pin 86, 286. Multiple manual override devices can also be used, if desired, to operate the same pin. It will be apparent to one of ordinary skill in the art that still other manual overrides can be used without departing from the present invention.

I claim:

1. A modular latch assembly, comprising:
a control element having a first state in which the control element has a first path of motion and a second state in which the control element has a second path of motion;
a pawl having latched and unlatched positions, the pawl being movable from the latched position to the unlatched position by the control element in its first state but not in its second state; and
at least two control element positions each dimensioned to receive a control element, the latch assembly having different operational modes corresponding to control elements occupying different control element positions, the control element occupying a first of the at least two control element positions.

2. The modular latch assembly as claimed in claim 1, wherein the latch assembly has at least two of at least three operational modes: a first mode in which the latch has one control element occupying the first control element position, a second mode in which the latch has one control element occupying a second control element position, and a third mode in which the latch has two control elements occupying the first and second control element positions

3. The modular latch assembly as claimed in claim 2, further comprising a first input element coupled to the control element, the first input element also coupled to a user-operable device external to the latch assembly for actuating the control element via the first input element.

4. The modular latch assembly as claimed in claim 2, wherein the control element is a first control element, the modular latch assembly further comprising a first input element coupled to a first user-operable device, the first input element also coupled to the first control element, the first input element interchangeably connectable to a second control element.

5. The modular latch assembly as claimed in claim 4, further comprising a second input element coupled to a second user-operable device, the second input element also coupled to the second control element, the second input element interchangeable connectable to the first control element.

6. The modular latch assembly as claimed in claim 4, further comprising a second input element coupled to a second user-operable device, the second input element also coupled to the first control element, wherein the first and second input elements are movable substantially independently with respect to one another so that actuation of one of the first and second input elements does not create substantial movement of another of the first and second input elements.

7. The modular latch assembly as claimed in claim 3, further comprising:
an engagement element coupled to the control element in the first state and decoupled from the control element in the second state;
a manual override having:
a second input element and
a second user-operable device coupled to the second input element, the second input element also coupled to the engagement element for movement of the engagement element into and out of coupled relationship with the control element.

8. The modular latch assembly as claimed in claim 7, further comprising a bell crank coupled between the second input element and the engagement element.

9. The modular latch assembly as claimed in claim 7, wherein the first and second input elements are movable substantially independently with respect to one another to permit actuation of one of the first and second input elements without substantial movement of another of the first and second input elements.

10. The modular latch assembly as claimed in claim 2, further comprising:
a first input element coupled to a first user-operable device, the first input element also selectively and interchangeably coupled to one of the pawl and the control element.

11. The modular latch assembly as claimed in claim 10, wherein the control element is a first control element, the modular latch assembly further comprising:
a second control element; and
a second input element coupled to a second user-operable device, the second input element also selectively and interchangeably coupled to one of the pawl, the first control element, and the second control element.

12. The modular latch assembly as claimed in claim 10, further comprising:
an engagement element coupled to the control element in the first state and decoupled from the control element in the second state;
a manual override having:
a second input element and
a second user-operable device coupled to the second input element, the second input element also coupled to the engagement element for movement of the engagement element into and out of coupled relationship with the control element.

13. The modular latch assembly as claimed in claim 12, further comprising a bell crank coupled between the second input element and the engagement element.

14. The modular latch assembly as claimed in claim 12, wherein the first and second input elements are movable substantially independently with respect to one another to permit actuation of one of the first and second input elements without substantial movement of another of the first and second input elements.

15. The modular latch assembly as claimed in claim 1, further comprising an input element coupled to the control element, the input element also coupled to a user-operable device external to the latch assembly for actuating the control element via the input element.

16. The modular latch assembly as claimed in claim 15, wherein the input element is one of a cable and a rod.

17. The modular latch assembly as claimed in claim 1, wherein the control element is movable into camming contact with a surface of the pawl in the first path of motion of the control element.

18. The modular latch assembly as claimed in claim 1, further comprising a link coupled to the control element at a first end and to the pawl at a second end, and wherein the pawl is movable between its latched and unlatched positions via the link and the control element in its first state.

19. The modular latch assembly as claimed in claim 1, further comprising a bell crank having a cam surface, the bell crank mounted to contact the control element in its first path of motion.

20. The modular latch assembly as claimed in claim 20, wherein the control element is a first control element, the modular latch assembly further comprising:
a second control element having a first state in which the second control element has a first path of motion and a second state in which the second control element has a second path of motion;
an engagement element coupled to the second control element in the first state and decoupled from the second control element in the second state, the bell crank coupled to the engagement element for movement of the engagement element into and out of coupled relationship with the second control element in response to camming motion of the first control element against the bell crank.

21. The modular latch assembly as claimed in claim 1, further comprising a bell crank having a cam surface, the bell crank mounted to contact the pawl during movement thereof.

22. The modular latch assembly as claimed in claim 1, further comprising:
an engagement element coupled to the control element in the first state and decoupled from the control element in the second state;
a bell crank; and
an input element coupled to a user-operable device and to the bell crank, the user-operable device movable to rotate the bell crank and to move the engagement element into and out of coupled relationship with the control element.

23. The modular latch assembly as claimed in claim 22, wherein the input element is movable substantially independently of pawl and control element movement to permit pawl and control element movement without substantial movement of the input element.

24. The modular latch assembly as claimed in claim 1, further comprising at least one bias element coupled to the control element for biasing the control element toward an at-rest position in the latch assembly.

25. A modular latch assembly comprising:
at least one control element having a first state in which the control element is rotatable about a first pivot point and an second state in which the control element is rotatable about a second pivot point;
a ratchet having a latched position and an unlatched position, the at least one control element capable of moving the ratchet from the latched position to the unlatched position when in the first state, the at least one control element incapable of moving the ratchet from the latched position to the unlatched position when in the second state,
the latch assembly being modular to receive control elements in at least two of at least three configurations: a first configuration in which the latch assembly has one control element occupying a first position in the latch assembly, a second configuration in which the latch assembly has one control element occupying a second position in the latch assembly, and a third configuration in which the latch assembly has two control elements occupying the first and second positions in the latch assembly.

26. The modular latch assembly claimed in claim 25, further comprising an engagement element having a first position in which the control element is placed in its first state and a second position in which the control element is placed in its second state, the engagement element defining the first pivot point when the engagement element is in its first position.

27. The modular latch assembly as claimed in claim 26, further comprising a manual override for moving the engagement element to at least one of its first and second positions.

28. The modular latch assembly as claimed in claim 27, wherein the manual override includes
a bell crank coupled to an engagement element and rotatable to move the engagement element into and out of coupled relationship with the control element;
an input element coupled to the bell crank for exerting rotational motion upon the bell crank; and
a user-operable device coupled to the input element.

29. The modular latch assembly as claimed in claim 25, further comprising a pawl between the at least one control element and the ratchet, the pawl having a latched position in which the ratchet is prevented from rotation and an unlatched position in which the ratchet can rotate, the pawl being movable to the unlatched position by movement of the at least one control element only in the first state.

30. The modular latch assembly as claimed in claim 25, further comprising an input element coupling each control element to a user-operable device external to the latch assembly, each input element capable of exerting motive force upon the control element coupled thereto.

31. The modular latch assembly as claimed in claim 30, wherein each input element rotates the control element coupled thereto.

32. The modular latch assembly as claimed in claim 30, wherein the input elements coupled to at least two-control elements are interchangeable.

33. The modular latch assembly as claimed in claim 30, further comprising:
a pawl coupled between the ratchet and the at least one control element; and
a pawl input element coupled to the pawl for direct actuation thereof;
the pawl and the ratchet each having respective latched and unlatched positions, the pawl preventing movement of the ratchet to its unlatched position when the pawl is in its latched position and permitting movement of the ratchet to its unlatched position when the pawl is in its unlatched position, wherein the pawl is movable to its unlatched position by actuation of the pawl input element.

34. The modular latch assembly as claimed in claim 30, further comprising a pawl coupled between the ratchet and the at least one control element, wherein at least one of the input elements is interchangeably connectable to the pawl and to one of the at least one control elements.

35. The modular latch assembly as claimed in claim 25, further comprising a pawl coupled between the ratchet and the at least one control element, wherein at least one control element in each configuration has a surface against which the pawl can press in the first state of the control element to move the pawl and release the ratchet.

36. The modular latch assembly as claimed in claim 25, further comprising a link coupled to the pawl and to the at least one control element, wherein the at least one control element is movable in its first state to move the pawl via the link to release the ratchet.
